(19) United States
(12) Patent Application Publication
(10) Pub. No.: US 2026/0278004 A1
(43) Pub. Date: Sep. 17, 2026

(54) RULE ENGINE USING DIRECTED PROPERTY GRAPHS

(71) Applicant: Infosys Limited, Bangalore (IN)

(72) Inventors: Steven SCHILDERS, Indianapolis, IN (US); Chitra THEAGARAJAN, Bengaluru (IN)

(73) Assignee: Infosys Limited, Bangalore (IN)

(21) Appl. No.: 19/078,771

(22) Filed: Mar. 13, 2025

(51) Int. Cl. G06F 16/901

(52) U.S. Cl. CPC G06F 16/9024

(57) ABSTRACT

A system for rule engine using directed property graphs is provided. A directed property graph is generated using various data rules. To generate the graph, a data node is created. A set of data rules, associated with the data node, is identified. Further, a set of rule nodes indicative of the set of data rules is created. The set of rule nodes is associated with the data node. Further, based on the association, the set of data rules is executed on the data node, and a set of rule outcomes is created. A set of rule outcome nodes indicative of the set of rule outcomes is then created. Further, the set of rule outcome nodes is associated with the set of rule nodes and the data node. The generated graph facilitates query response generation.

### FIELD OF THE DISCLOSURE

Various embodiments of the present disclosure relate generally to directed property graphs. More specifically, various embodiments of the present disclosure relate to rule engine using directed property graphs.

### BACKGROUND

In today's world, data may play a crucial and indispensable role across various domains (for example, research and development, machine learning model training, or the like). Each domain may rely on distinct types of data to meet specific requirements of tasks at hand. Therefore, before data can be used, the data must be evaluated to ensure it aligns with the requirements of the particular task it is intended for. Traditionally, the data evaluation may involve a third-party solution (for example, a data analysis system). Therefore, the data may be shared with these external systems, which can be inconvenient and undesirable. Further, in time-critical scenarios, this external evaluation process can introduce delays, negatively impacting the task at hand. Additionally, when the data is confidential or sensitive, sharing it with third-party solutions may potentially compromise data security.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for rule engine using directed property graphs are provided substantially as shown in, and described in connection with, at least one of the figures.

In an embodiment of the present disclosure, a system is disclosed. The system includes processing circuitry configured to generate a graph based on a plurality of data rules. To generate the graph, the processing circuitry is further configured to create a first set of rule nodes indicative of the first set of data rules. The processing circuitry is further configured to associate the first set of rule nodes with the first data node. Based on the association of the first set of rule nodes with the first data node, the processing circuitry is further configured to execute the first set of data rules to generate a first set of rule outcomes. Further, the processing circuitry is configured to create a first set of rule outcome nodes indicative of the first set of rule outcomes, and associate the first set of rule outcome nodes with the first set of rule nodes and the first data node. The generated graph facilitates query response generation.

In some embodiments, a data rule, of the plurality of data rules, adheres to one of a group consisting of completeness, uniqueness, consistency, accuracy, or conformity.

In some embodiments, to associate the first set of rule nodes with the first data node, the processing circuitry is further configured to create a set of data-rule edges between the first data node and the first set of rule nodes, with a data-rule edge being created between the first data node and a first rule node of the first set of rule nodes.

In some embodiments, the processing circuitry is further configured to determine, for the first data node, a first set of data attributes that indicates characteristics of the first data node. The processing circuitry is further configured to determine, for the first rule node, a first set of rule attributes that comprises at least one of a group consisting of (i) a category of a first data rule, of the first set of data rules, indicated by the first rule node or (ii) a type of the first data rule. Further, the processing circuitry is configured to determine for the data-rule edge, a set of edge attributes that comprises at least one of a group consisting of (i) a scope of the first data rule, (ii) at least one data attribute, of the first set of data attributes, on which the first data rule is to be executed, or (iii) one or more additional attributes defining a criterion associated with the execution of the first data rule, and associate the first set of data attributes as node properties of the first data node, the first set of rule attributes as node properties of the first rule node, and the set of edge attributes as edge properties of the data-rule edge.

In some embodiments, the set of edge attributes of the data-rule edge further comprises one or more data attributes, of the first set of data attributes, that are excluded from the execution of the first data rule.

In some embodiments, the scope of the first data rule indicates whether the first data rule is to be executed on the first data node in entirety or on a data attribute of the first data node.

In some embodiments, the first data rule is executed on an attribute value of the at least one data attribute included in the set of edge attributes. A first rule outcome, of the first set of rule outcomes, associated with the execution of the first data rule is determined based on the one or more additional attributes.

In some embodiments, the set of edge attributes of the data-rule edge further comprises an identifier of the first data node, an identifier of the first rule node, the category of the first data rule, and the type of the first data rule.

In some embodiments, the category of the first data rule corresponds to one of a group consisting of completeness, uniqueness, consistency, accuracy, or conformity.

In some embodiments, each of the first set of rule outcomes corresponds to one of a group consisting of true or false.

In some embodiments, the first set of rule outcomes is indicative of evaluation of the first data node based on a set of data analysis parameters associated with the first set of data rules.

In some embodiments, a data analysis parameter, of the set of data analysis parameters, corresponds to one of a group consisting of a completeness parameter, a uniqueness parameter, a consistency parameter, an accuracy parameter, and a conformity parameter.

In some embodiments, to associate the first set of rule outcome nodes with the first set of rule nodes and the first data node, the processing circuitry is further configured to create a set of outcome-rule edges between the first set of rule outcome nodes and the first set of rule nodes, with an outcome-rule edge being created between a first rule outcome node, of the first set of rule outcome nodes, and a first rule node, of the first set of rule nodes. The processing circuitry is further configured to create a set of outcome-data edges between the first set of rule outcome nodes and the first data node, with an outcome-data edge being created between the first rule outcome node and the first data node.

In some embodiments, the processing circuitry is further configured to determine, for the first rule outcome node, a first set of outcome attributes that comprises at least one of a group consisting of (i) a first timestamp associated with the execution of a first data rule, of the first set of data rules, indicated by the first rule node, using the first data node, or (ii) a first rule outcome, of the first set of rule outcomes, associated with the execution of the first data rule, and associate the first set of outcome attributes as node properties of the first rule outcome node.

In some embodiments, the processing circuitry is further configured to determine, for the outcome-rule edge, a set of edge attributes that comprises (i) a category of a first data rule, of the first set of data rules, indicated by the first rule node, (ii) a type of the first data rule, (iii) a first timestamp associated with the execution of the first data rule using the first data node, or (iv) a first rule outcome, of the first set of rule outcomes, associated with the execution of the first data rule, and associate the determined set of edge attributes as edge properties thereof. Further, the processing circuitry is configured to determine, for the outcome-data edge, another set of edge attributes that comprises (i) the first timestamp, (ii) an attribute value of each data attribute, of the first data node, on which the first data rule is executed, or (iii) the first rule outcome, and associate the determined set of edge attributes as edge properties thereof.

In some embodiments, the set of edge attributes of the outcome-rule edge further comprises an identifier of the first rule node and an identifier of the first rule outcome node. The set of edge attributes of the outcome-data edge further comprises an identifier of the first data node, the identifier of the first rule node, and the identifier of the first rule outcome node.

In some embodiments, the processing circuitry is further configured to associate an identifier of the first data node as node properties of the first data node. The processing circuitry is further configured to associate an identifier of a first rule node, of the first set of rule nodes, as node properties of the first rule node. The processing circuitry is further configured to associate an identifier of a first rule outcome node, of the first set of rule outcome nodes, as node properties of the first rule outcome node.

In some embodiments, a first rule outcome node, of the first set of rule outcome nodes, is created based on an execution of a first data rule, of the first set of data rules, indicated by a first rule node, of the first set of rule nodes, using the first data node at a first time instance. Further, a second rule outcome node, of the first set of rule outcome nodes, is created based on the execution of the first data rule using the first data node at a second time instance.

In some embodiments, to associate the first set of rule outcome nodes with the first set of rule nodes and the first data node, the processing circuitry is further configured to create a first outcome-rule edge between the first rule outcome node and the first rule node. Further, node properties of the first rule outcome node comprise (i) a first timestamp indicative of the first time instance or (ii) a first rule outcome, of the first set of rule outcomes, associated with the execution of the first data rule using the first data node at the first time instance. The processing circuitry is further configured to create a first outcome-data edge between the first rule outcome node and the first data node. Further, edge properties of the first outcome-data edge comprise (i) the first timestamp, (ii) an attribute value, associated with the first data node, on which the first data rule is executed at the first time instance, or (iii) the first rule outcome.

In some embodiments, to associate the first set of rule outcome nodes with the first set of rule nodes and the first data node, the processing circuitry is further configured to create a second outcome-rule edge between the second rule outcome node and the first rule node. Further, node properties of the second rule outcome node comprise (i) a second timestamp indicative of the second time instance, or (ii) a second rule outcome, of the first set of rule outcomes, associated with the execution of the first data rule using the first data node at the second time instance. Further, the processing circuitry is configured to create a second outcome-data edge between the second rule outcome node and the first data node. Further, edge properties of the second outcome-data edge comprise (i) the second timestamp, (ii) an attribute value, associated with the first data node, on which the first data rule is executed at the second time instance, or (iii) the second rule outcome.

In some embodiments, the execution of the first data rule using the first data node at the second time instance is based on a change in an attribute value associated with the first data node.

In some embodiments, to associate a first rule node, of the first set of rule nodes, with the first data node, the processing circuitry is further configured to create a first data-rule edge and a second data-rule edge between the first data node and the first rule node. Further, edge properties of the first data-rule edge comprise at least one of a group consisting of (i) a category of a first data rule, of the first set of data rules, indicated by the first rule node, (ii) a type of the first data rule, (iii) a scope of the first data rule, (iv) a first data attribute of the first data node on which the first data rule is to be executed, or (v) a first set of additional attributes defining a first criterion associated with the execution of the first data rule. Further, edge properties of the second data-rule edge comprise at least one of a group consisting of (i) the category of the first data rule, (ii) the type of the first data rule, (iii) the scope of the first data rule, (iv) a second data attribute of the first data node on which the first data rule is to be executed, or (v) a second set of additional attributes defining a second criterion associated with the execution of the first data rule.

In some embodiments, the first data rule is executed on a first attribute value of the first data attribute at a first time instance. A first rule outcome, of the first set of rule outcomes, associated with the execution of the first data rule on the first attribute value is determined based on the first set of additional attributes. A first rule outcome node, of the first set of rule outcome nodes, indicates the first rule outcome. Further, the first data rule is executed on a second attribute value of the second data attribute at a second time instance. A second rule outcome, of the first set of rule outcomes, associated with the execution of the first data rule on the second attribute value is determined based on the second set of additional attributes. A second rule outcome node, of the first set of rule outcome nodes, indicates the second rule outcome.

In some embodiments, to associate the first set of rule outcome nodes with the first set of rule nodes and the first data node, the processing circuitry is further configured to create a first outcome-rule edge between the first rule outcome node and the first rule node. Further, node properties of the first rule outcome node comprise at least one of the first rule outcome or a first timestamp indicative of the first time instance. The processing circuitry is further configured to create a first outcome-data edge between the first rule outcome node and the first data node. Further, edge properties of the first outcome-data edge comprise at least one of the first timestamp, the first attribute value, or the first rule outcome. The processing circuitry is further configured to create a second outcome-rule edge between the second rule outcome node and the first rule node. Further, node properties of the second rule outcome node comprise at least one of the second rule outcome or a second timestamp indicative of the second time instance. The processing circuitry is further configured to create a second outcome-data edge between the second rule outcome node and the first data node. Further, edge properties of the second outcome-data edge comprise at least one of the second timestamp, the second attribute value, or the second rule outcome.

In some embodiments, to generate the graph, the processing circuitry is further configured to create a second data node. The processing circuitry is further configured to identify, from the plurality of data rules, a second set of data rules associated with the second data node. Further, the first set of data rules and the second set of data rules have at least one common data rule. The processing circuitry is further configured to associate, with the second data node, a common rule node, of the first set of rule nodes, that indicates the at least one common data rule. Further, based on the association of the common rule node with the second data node, the at least one common data rule is executed using the second data node to generate another rule outcome. The processing circuitry is further configured to create another rule outcome node indicative of the other rule outcome generated based on the execution of the at least one common data rule using the second data node. Further, the processing circuitry is configured to associate the other rule outcome node with the common rule node and the second data node.

In some embodiments, the processing circuitry executes the first set of data rules further based on a change associated with the system.

In some embodiments, to associate the first set of rule nodes with the first data node, the processing circuitry is further configured to create a ruleset node for the first set of data rules. The processing circuitry is further configured to create a data-ruleset edge between the first data node and the ruleset node. Further, the processing circuitry is configured to create a set of ruleset-rule edges between the ruleset node and the first set of rule nodes, with a ruleset-rule edge being created between the ruleset node and a first rule node of the first set of rule nodes.

In some embodiments, the processing circuitry is further configured to associate, as node properties of the first data node, a first set of data attributes that indicates characteristics of the first data node. Further, the processing circuitry is configured to associate, as node properties of the ruleset node, a category of the first set of data rules. The processing circuitry is further configured to associate, as node properties of the first rule node, a type of a first data rule indicated by the first rule node. Further, the processing circuitry is configured to associate, as edge properties of the data-ruleset edge, at least one data attribute, of the first set of data attributes, on which the first set of data rules is to be executed. The processing circuitry is further configured to associate as edge properties of the ruleset-rule edge, one or more additional attributes defining a criterion associated with the execution of the first data rule.

In some embodiments, the first data rule is executed on an attribute value of the at least one data attribute included in the edge properties of the data-ruleset edge. A first rule outcome, of the first set of rule outcomes, associated with the execution of the first data rule on the attribute value of the at least one data attribute is determined based on the one or more additional attributes associated as the edge properties of the ruleset-rule edge.

In some embodiments, to associate the first set of rule outcome nodes with the first set of rule nodes and the first data node, the processing circuitry is further configured to create an outcome-set node for the first set of rule outcomes. Further, the processing circuitry is configured to create an outcome-set-data edge between the outcome-set node and the first data node. The processing circuitry is further configured to create an outcome-set-ruleset edge between the outcome-set node and the ruleset node. The processing circuitry is further configured to create a set of outcome-set-outcome edges between the outcome-set node and the first set of rule outcome nodes, with an outcome-set-outcome edge being created between the outcome-set node and a first rule outcome node of the first set of rule outcome nodes.

In some embodiments, the processing circuitry is further configured to associate, as node properties of the first rule outcome node, at least one of a group consisting of (i) a first timestamp associated with the execution of a first data rule, of the first set of data rules, indicated by the first rule node, using the first data node, or (ii) a first rule outcome, of the first set of rule outcomes, associated with the execution of the first data rule. Further, the processing circuitry is configured to associate, as edge properties of the outcome-set-outcome edge, at least one of the group consisting of the first timestamp or the first rule outcome.

In some embodiments, the processing circuitry is further configured to receive a query that comprises a reference value. The processing circuitry is further configured to identify, in the graph, at least one node having a data value that is associated with the reference value such that the identified node corresponds to one of a group consisting of a data node or a rule node. Further, the processing circuitry is configured to identify a set of edges associated with the identified node. The processing circuitry is further configured to identify a set of nodes linked to the identified set of edges. The identified set of nodes includes at least one of a group consisting of one or more data nodes, one or more rule nodes, or one or more rule outcome nodes. The processing circuitry is further configured to generate a response to the query based on at least one of a group consisting of (i) the identified node, (ii) node properties of the identified node, (iii) the set of edges, (iv) edge properties of each of the set of edges, (v) the set of nodes, or (vi) node properties of each of the set of nodes.

In some embodiments, a method is disclosed. The method comprises generating, by processing circuitry, a graph based on a plurality of data rules. The step of generating the graph further comprises creating, by the processing circuitry, a first data node. The step of generating the graph further comprises identifying, by the processing circuitry, from the plurality of data rules, a first set of data rules associated with the first data node. Further, the step of generating the graph comprises creating, by the processing circuitry, a first set of rule nodes indicative of the first set of data rules. The step of generating the graph further comprises associating, by the processing circuitry, the first set of rule nodes with the first data node. Further, the step of generating the graph comprises executing, by the processing circuitry, based on the association of the first set of rule nodes with the first data node, the first set of data rules to generate a first set of rule outcomes. The step of generating the graph further comprises creating, by the processing circuitry, a first set of rule outcome nodes indicative of the first set of rule outcomes, and associating, by the processing circuitry, the first set of rule outcome nodes with the first set of rule nodes and the first data node. The generated graph facilitates query response generation.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a block diagram that illustrates a system environment for rule engine using directed property graphs, consistent with disclosed embodiments of the present disclosure;

FIG. 2 is a graph that illustrates an association between a data node, a rule node, and a rule outcome node, consistent with disclosed embodiments of the present disclosure;

FIG. 3 is a graph that illustrates rule execution at different time instances, consistent with disclosed embodiments of the present disclosure;

FIG. 4 is a graph that illustrates execution of the same data rule on multiple data attributes, consistent with the disclosed embodiments of the present disclosure;

FIG. 5 is a graph that illustrates sharing of a rule node between two data nodes, consistent with disclosed embodiments of the present disclosure;

FIG. 6 is a graph that illustrates association between data nodes, ruleset nodes, and outcome-set nodes, consistent with disclosed embodiments of the present disclosure;

FIG. 7 illustrates an example computing system for carrying out the methods of the present disclosure, consistent with disclosed embodiments of the present disclosure; and

FIGS. 8A and 8B, collectively, represents a flowchart that illustrates a method for facilitating rule engine using directed property graphs, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

In recent times, data has become crucial across various domains (for example, artificial intelligence, research and development, marketing, hospitality, inventory management, or the like). These domains rely on data to perform a wide range of operations, each with specific requirements that the data must satisfy to ensure successful execution. Therefore, the data is required to be evaluated to determine its compliance with these operational requirements. Presently, the data evaluation is conducted using external data analysis systems, typically in an offline manner. This approach involves sending the data to the external system for evaluation, causing the associated operation to pause until the evaluation is complete. Such delays may lead to a delay in the execution of the operation, and in some cases, may create bottlenecks. Moreover, the requirements for the data evaluation are often dynamic. Therefore, the external system must be updated with the latest requirements, which can be repetitive, inconvenient, and prone to human error. In some instances, when the operation may be time-critical, the delay may be unfavorable and have a negative impact on the operation. Additionally, if the data being evaluated is confidential or sensitive, involving a third-party system for evaluation increases the risk of exposure, potentially compromising data security.

The present disclosure provides a unique approach for efficient and secure data evaluation. The present disclosure discloses a graph (e.g., a directed property graph) generated using various data rules associated with a real-time system. The data associated with the real-time system may be represented in the form of data nodes. That is to say, one or more data nodes may be created in the graph to represent the data. Further, one or more data rules may be configured for evaluation of each data node (e.g., associated data). Thus, rule nodes, indicative of the data rules, may be created and associated with the data node for which the evaluation is to be performed. The evaluation may be performed in a periodic manner or in response to a change event associated with the real-time system. Further, based on the execution of the data rules, one or more rule outcomes may be generated. In such a scenario, rule outcome nodes, indicative of the rule outcomes, may be created in the graph. The data nodes, the rule nodes, and the outcome nodes may be coupled by way of edges. Each node and edge of the graph may have various attributes associated as properties thereof.

Such a graph allows the concurrent presence of the data and the data rules in the graph. Additionally, the outcomes of the data evaluation, i.e., rule outcome nodes, are also present in the same graph. Such a structure allows efficient access to data evaluation outcomes whilst ensuring data security. In such a graph, the query processing may start from the data node or the rule node. Further, other relevant nodes may be identified using the edges linked thereto. Using the identified edges and nodes, rule outcomes may be determined. Further, a query response including the rule outcomes may be generated to indicate the quality of the data. In some cases, if the data quality meets the required standard, the data may be used for various purposes. For example, the data may be used as a training dataset for training various machine learning models. In contrast, if the data quality is suboptimal, corrective measures may be taken to improve the quality of the data. Such a graph allows efficient identification of the areas where the quality of the data is suboptimal based on the data rules associated with the data. It is appreciated that the human mind is not equipped to conceptualize an optimized association of rule nodes with corresponding data nodes in the directed property graph, given the digital interconnectedness of the association.

The present disclosure provides numerous advantages including optimized and organized association of rule nodes with corresponding data nodes. The data is available to be used as soon as it is analyzed and without any significant delay. Further, the association of the data rules with the data allows analysis of the data sans the involvement of any external third-party system. Therefore, the present disclosure allows for data analysis to be performed without compromising the data security.

### Figure Description

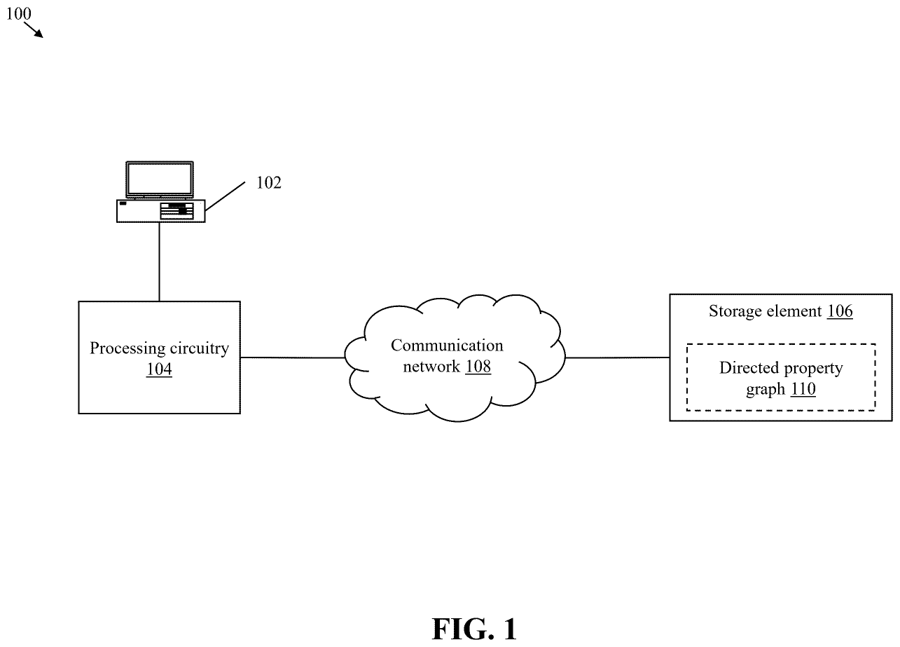

FIG. 1 is a block diagram that illustrates a system environment 100 for rule engine using directed property graphs, consistent with disclosed embodiments of the present disclosure. In today's fast-paced world, real-world problems (e.g., fraud detection, healthcare, traffic congestion, or the like) require real-time analytics for quick and efficient decision-making. Such an approach may require optimization at every stage of problem-solving. A problem may be solved by making a decision based on the available data. Hence, for making accurate and optimal decisions, the available data has to accord with reliability and optimality.

Typically, the data analysis system is a third-party system. Hence, the data to be analyzed is required to be shared with the third-party system. In this scenario, the data may be compromised and may be left vulnerable. Moreover, such data analysis may lead to unavailability of the trustable data for decision-making. Additionally, the data may be constantly changing and evolving. In such a scenario, the output generated by the third-party system may be outdated. Such inaccurate results are undesired, especially in areas such as healthcare. Therefore, efficient and accurate data quality analysis may be important for real-time analytics and decision-making.

The present disclosure provides a solution to implement accurate and efficient data analysis for decision-making by storing data and data rules together in directed property graphs. A directed property graph is a graph data model consisting of nodes, edges, and properties, where edges have direction and both nodes and edges can store key-value pairs, allowing for complex data representation and efficient querying. Referring to FIG. 1, the system environment 100 may include a real-time system 102, processing circuitry 104, a storage element 106, and a communication network 108. The processing circuitry 104 may be configured to access the storage element 106 via the communication network 108.

The real-time system 102 may represent a distributed platform that encompasses various microservices for the resolution of real-world problems. Each microservice may be associated with various entities and may have data associated therewith. For example, in a healthcare microservice, the entities may correspond to patients and the data may correspond to patient details, such as name, address, historical health records, or the like. Each microservice may require analysis of the data for decision-making. For example, each microservice may be associated with various system operations, such as updating data, initiating specific tasks, or facilitating data exchange, and each system operation may have different data requirements. Therefore, before its use, the data may be required to adhere to different sets of data rules.

The processing circuitry 104 may include suitable logic, circuitry, interfaces, and/or code, executable by the circuitry, that may be configured to perform optimized data analysis. The processing circuitry 104 may be configured to generate (e.g., derive) a directed property graph 110 based on the data and the data rules associated with the real-time system 102, and store the directed property graph 110 in the storage element 106. Examples of the storage element 106 may include, but are not limited to, a random-access memory (RAM), a read-only memory (ROM), a removable storage drive, a hard disk drive (HDD), a flash memory, a solid-state memory, or the like.

### Generation of the Directed Property Graph 110

To generate the directed property graph 110, the processing circuitry 104 may execute various operations. For example, the processing circuitry 104 may be configured to create a data node to represent one or more data values associated with the real-time system 102. Further, the processing circuitry 104 may be configured to identify various data rules associated with the data node. The processing circuitry 104 may be further configured to create rule nodes indicative of the identified data rules and associate the rule nodes with the data node. Based on the association, the processing circuitry 104 may be further configured to execute each data rule on the data node to generate a corresponding rule outcome. Further, the processing circuitry 104 may be configured to create a rule outcome node indicative of the rule outcome generated for the execution of each data rule and associate the rule outcome node with the data node and the rule node representing the corresponding data rule. The association between nodes may be executed by way of edges. For example, the rule nodes may be associated with the data node by way of data-rule edges, the rule outcome nodes may be associated with the rule nodes by way of outcome-rule edges, and the rule outcome nodes may be associated with the data node by way of outcome-data edges. Further, for each node (e.g., data, rule, or rule outcome node), the processing circuitry 104 may be configured to determine and associate one or more attributes as properties thereof.

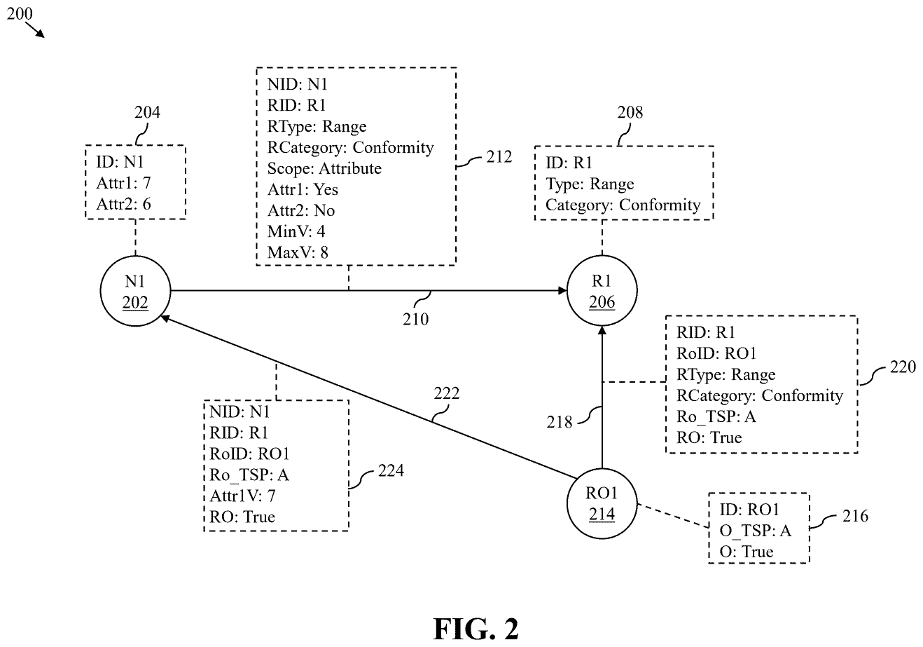

In an embodiment, the processing circuitry 104 may receive a query. The query may pertain to a data quality analysis to be executed on data stored in the directed property graph 110. The query may comprise a reference value. The processing circuitry 104 may be configured to identify, in the directed property graph 110, at least one node having a data value that is associated with (e.g., is identical to) the reference value included in the query. The identified node may correspond to one of a group consisting of a data node or a rule node. The processing circuitry 104 may be further configured to identify a set of edges associated with the identified node. Further, the processing circuitry 104 may be configured to identify a set of nodes linked to the identified set of edges. The identified set of nodes may include at least one of a group consisting of one or more data nodes, one or more rule nodes, or one or more rule outcome nodes. In such a scenario, the processing circuitry 104 may be further configured to generate a response to the query based on the identified node, node properties of the identified node, the identified set of edges, edge properties of each of the identified set of edges, the identified set of nodes, node properties of each of the identified set of nodes, or a combination thereof. The response may indicate the data quality of the real-time system 102. In some cases, if the data quality meets the required standard, the data may be used for various system operations. For example, the data may be used as a training dataset for training various machine learning models. In contrast, if the data quality is suboptimal, corrective measures may be taken to improve the data quality. The structure of the directed property graph 110 is explained in detail in conjunction with FIGS. 2-7.

Thus, to create the directed property graph 110, the data and the data rules are modeled together. The association of the data and the data rules allows efficient execution of the query. Further, the creation of the data nodes, the rule nodes, and the outcome nodes may allow tracing the data lineage, the rule lineage, and the outcome lineage, respectively. Such lineages may in turn provide an insight into the improvement or the degradation of the data quality. Such lineages may also help in taking corrective measures to improve the data quality. The higher quality data may further aid in efficient and accurate decision-making.

The processing circuitry 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person of ordinary skill in the art that the processing circuitry 104 may be compatible with multiple operating systems. The processing circuitry 104 may further include one or more components (for example, a parser, a loader, or the like) that may be configured to execute one or more operations to be executed by the processing circuitry 104.

The communication network 108 is a medium through which instructions and data are transmitted between the processing circuitry 104 and the storage element 106. Examples of the communication network 108 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, microwave communication, and a combination thereof. Examples of the communication network 108 may further include a Narrow Band-Internet of Things (NB-IoT) network, a 5G network, a 4G network, a long-range (LoRa) wireless technology network, a ZigBee network, an IPv6 Low-power Wireless Personal Area Network (6LowPAN), or the like. Various entities (such as the processing circuitry 104 and the storage element 106) in the system environment 100 may be coupled to the communication network 108 in accordance with various wired and wireless communication protocols, such as Transmission Control Protocol and Internet Protocol (TCP/IP), User Datagram Protocol (UDP), Long Term Evolution (LTE) communication protocols, or any combination thereof.

Although the present disclosure describes the generation and utilization of a directed property graph (e.g., the directed property graph 110), the scope of the present disclosure is not limited to it. In numerous embodiments, other types of graphs, such as undirected graphs, weighted graphs, bipartite graphs, or the like, may be utilized without deviating from the scope of the present disclosure.

The scope of the present disclosure is not limited to a standalone realization of the storage element 106, as described herein. In numerous embodiments, the storage element 106 can be realized in the form of a database server or a cloud storage working in conjunction with the processing circuitry 104, without departing from the scope of the present disclosure.

FIG. 2 is a graph 200 that illustrates an association between a data node, a rule node, and a rule outcome node, consistent with disclosed embodiments of the present disclosure. The graph 200 may correspond to a portion of the directed property graph 110.

### Data Rules

In an embodiment, a system operation associated with the real-time system 102 may involve the utilization of a dataset associated with the real-time system 102. In such a scenario, prior to its use, the dataset may have to be evaluated to determine whether the dataset meets the requirement of the corresponding system operation. For evaluation of the dataset, the real-time system 102 may be further associated with a rule engine (e.g., the processing circuitry 104). The processing circuitry 104 may be configured to evaluate the dataset based on a plurality of data rules associated with the real-time system 102.

Each data rule, of the plurality of data rules, may be associated with a corresponding category. The category of a data rule may correspond to one of a group consisting of completeness, uniqueness, consistency, accuracy, or conformity. Thus, each data rule, of the plurality of data rules, may adhere to one of a group consisting of completeness, uniqueness, consistency, accuracy, or conformity. Hence, the evaluation of the dataset using the plurality of data rules may correspond to the evaluation of the dataset based on a set of data analysis parameters associated with the plurality of data rules. A data analysis parameter may define a property, a constraint, a condition, or the like, that is to be adhered to by the dataset so that it is usable for various system operations. A data analysis parameter may thus correspond to one of a group consisting of a completeness parameter, a uniqueness parameter, a consistency parameter, an accuracy parameter, or a conformity parameter.

The completeness parameter may refer to a constraint that defines a data element of the dataset to be an essential data element. That is to say that the presence of the data element may be essential for the usability of the dataset. The uniqueness parameter may refer to a constraint that ensures no duplication of data elements within the dataset. One or more data elements of the dataset may also be included in one or more other datasets of the real-time system 102. The consistency parameter may refer to a constraint that ensures a value of the data element remains consistent/same in each dataset that includes the data element. The accuracy parameter may refer to a degree to which the dataset correctly describes corresponding real-world objects. The accuracy parameter is evaluated by verifying data elements of the dataset with an originating source or a trusted external source. The conformity parameter may refer to a constraint that defines a range for the value of the data element of the dataset. The dataset may not be usable for any system operations when the value of the data element is outside the range.

Although it is described that the evaluation of the dataset is based on one of a group consisting of a completeness parameter, a uniqueness parameter, a consistency parameter, an accuracy parameter, or a conformity parameter, the scope of the present disclosure is not limited to it. In numerous embodiments, various other parameters may be utilized for evaluating a dataset.

Each data rule may also have a rule type associated therewith. The rule type of the data rule may explicitly define an execution context of the data rule for the associated category. For example, a data rule having the conformity category may have rule types such as range, length, format, or the like. If the rule type of the data rule having the conformity category corresponds to the range, the data rule may conform to whether the data values of the data elements adhere to a specified range. Similarly, if the rule type of the data rule having the conformity category corresponds to length, the data rule may conform to whether the data values of the data elements adhere to a specified length. Further, if the rule type of the data rule having the conformity category corresponds to the format, the data rule may conform to whether the data values of the data elements adhere to a specified format.

### Generation of the Graph 200

The processing circuitry 104 may be configured to generate the graph 200 based on the plurality of data rules and the dataset associated with the real-time system 102. To generate the graph 200, the processing circuitry 104 may execute various operations. For example, the processing circuitry 104 may be configured to create a data node 202 representing a first data record of the dataset. In an example, the dataset may correspond to an employee dataset, and the data node 202 may represent a first employee of the employee dataset. The processing circuitry 104 may be further configured to determine a set of data attributes for the data node 202. The set of data attributes may indicate characteristics of the data node 202. In the above example, the set of data attributes may indicate characteristics of the first employee such as the name of the first employee, the age of the first employee, the address of the first employee, the number of working hours of the first employee, or the like. Further, the data node 202 may have an identifier (ID) associated therewith. The processing circuitry 104 may be further configured to associate the ID and the determined set of data attributes as node properties of the data node 202. The node properties of the data node 202 are shown within a dotted box 204 associated with the data node 202. The dotted box 204 is shown to include some of the node properties in the form of key-value pairs such as ID: ‘N1’, a first data attribute (denoted as “Attr1” in the FIG. 2): ‘7’, and a second data attribute (denoted as “Attr2” in the FIG. 2): ‘6’. In an example, the first data attribute may correspond to the number of working hours of the first employee and the second data attribute may correspond to the productivity score of the first employee. Although not shown, the dotted box 204 may also include other data attributes such as the name, the address, or the like.

The processing circuitry 104 may be further configured to identify, from the plurality of data rules, at least a first data rule associated with the data node 202. In an embodiment, the first data rule may be associated with the conformity category. The processing circuitry 104 may be further configured to create a rule node 206 indicative of the first data rule. Further, the processing circuitry 104 may be configured to determine a first set of rule attributes for the rule node 206. The first set of rule attributes may include at least one of a category of the first data rule or a type of the first data rule. Additionally, the rule node 206 may have an ID associated therewith. The processing circuitry 104 may be further configured to associate the ID and the first set of rule attributes as node properties of the rule node 206. The node properties of the rule node 206 are shown within a dotted box 208 associated with the rule node 206. The dotted box 208 is shown to include some of the node properties in the form of key-value pairs such as ID: ‘R1’, type: ‘range’, and category: ‘conformity’.

The processing circuitry 104 may be further configured to associate the rule node 206 with the data node 202. To associate the rule node 206 with the data node 202, the processing circuitry 104 may be further configured to create a data-rule edge 210 between the data node 202 with the rule node 206. The processing circuitry 104 may be further configured to determine a set of edge attributes for the data-rule edge 210. The set of edge attributes may include at least one of a group consisting of a scope of the first data rule, at least one data attribute (for example, the first data attribute) on which the first data rule is to be executed, one or more data attributes (for example, the second data attribute) that are excluded from the execution of the first data rule, one or more additional attributes, the ID of the data node 202, the ID of the rule node 206, the category of the first data rule, or the type of the first data rule. The one or more additional attributes may define a criterion associated with the execution of the first data rule. The scope of the first data rule may indicate whether the first data rule is to be executed on the data node 202 in entirety or on a data attribute of the data node 202.

The processing circuitry 104 may be further configured to associate the determined set of edge attributes as edge properties of the data-rule edge 210. The edge properties of the data-rule edge 210 are shown within a dotted box 212 associated with the data-rule edge 210. The dotted box 212 is shown to include some of the edge properties in the form of key-value pairs such as data node ID (denoted as “NID” in FIG. 2): ‘N1’, rule node ID (denoted as “RID” in FIG. 2): ‘R1’, rule type (denoted as “RType” in FIG. 2): ‘range’, rule category (denoted as “RCategory” in FIG. 2): ‘conformity’, scope: ‘attribute’, Attrl: ‘Yes’, Attr2: ‘No’, minimum value (denoted in FIG. 2 as “MinV”): ‘4’, and maximum value (denoted as “Max V” in FIG. 2): ‘8’. In an example, if the first data attribute corresponds to the number of working hours of the first employee, the one or more additional attributes may include a minimum value of the permitted working hours and a maximum value of the permitted working hours.

Based on the association of the rule node 206 with the data node 202, the processing circuitry 104 may be configured to execute the first data rule to generate a first rule outcome. The first data rule is executed at a first time instance indicative of a first timestamp. The set of edge attributes (e.g., ‘Yes’ value of the first data attribute) of the data-rule edge 210 indicates that the scope of the first data rule includes execution of the first data rule on a data attribute of the data node 202, and the data attribute on which the first data rule is to be executed is the first data attribute. Thus, the first data rule is executed on an attribute value of the first data attribute. Additionally, as the set of edge attributes of the data-rule edge 210 indicates that the first data rule is not to be executed on the second data attribute, the first data rule is not executed on the second data attribute.

Thus, in an example, the first data rule may be designed to check whether the number of working hours associated with the first employee being represented by the data node 202 conforms to a range of 4-8. In other words, the first rule outcome associated with the execution of the first data rule is determined based on the one or more additional attributes (e.g., the minimum and maximum values). The first rule outcome may correspond to one of a group consisting of true or false. For example, if the number of working hours associated with the first employee is in the range of 4-8, the first rule outcome is true. Conversely, if the number of working hours associated with the first employee is outside the range of 4-8, the first rule outcome is false. In the example shown in FIG. 2, the first data attribute value is ‘7’. Thus, the first rule outcome is true. The first rule outcome is thus indicative of the evaluation of the data node 202 based on a data analysis parameter (e.g., the conformity parameter) associated with the first data rule. Evaluation of the data node 202 based on other data analysis parameters, such as a completeness parameter, a uniqueness parameter, a consistency parameter, or an accuracy parameter, may be executed in a similar manner as described above.

In an embodiment, the processing circuitry 104 executes the first data rule further based on a change associated with the real-time system 102. In some embodiments, the change associated with the real-time system 102 may correspond to an update of an attribute value associated with a data attribute. In other embodiments, the change associated with the real-time system 102 may correspond to the addition of a new data record in the dataset. In numerous embodiments, the change may correspond to a lapse of a periodic time interval. In other words, the data rules are executed in the event of an update operation, a create operation, or at periodic time intervals.

The processing circuitry 104 may be further configured to create a rule outcome node 214 that may be indicative of the first rule outcome. The processing circuitry 104 may be further configured to determine a set of outcome attributes for the rule outcome node 214. The set of outcome attributes may include at least one of a group consisting of the first rule outcome or the first timestamp associated with the execution of the first data rule using the data node 202. The rule outcome node 214 may have an ID associated therewith. Further, the processing circuitry 104 may be configured to associate the ID and the set of outcome attributes as node properties of the rule outcome node 214. The node properties of the rule outcome node 214 are shown within a dotted box 216 associated with the rule outcome node 214. The dotted box 216 is shown to include the node properties in the form of key-value pairs such as the ID: ‘RO1’, the first timestamp (denoted as “O_TSP” in FIG. 2): ‘A’, and the first rule outcome (denoted as ‘O’in FIG. 2): ‘true’.

The processing circuitry 104 may be further configured to associate the rule outcome node 214 with the rule node 206 and the data node 202. To associate the rule outcome node 214 with the rule node 206, the processing circuitry 104 may be further configured to create an outcome-rule edge 218 between the rule outcome node 214 and the rule node 206. The processing circuitry 104 may be further configured to determine a set of edge attributes for the outcome-rule edge 218. The set of edge attributes of the outcome-rule edge 218 may include at least one of the category of the first data rule, the type of the first data rule, the first timestamp, the first rule outcome, the ID of the rule outcome node 214, or the ID of the rule node 206. The processing circuitry 104 may be further configured to associate the set of edge attributes of the outcome-rule edge 218 as edge properties thereof. The edge properties of the outcome-rule edge 218 are shown in a dotted box 220. The dotted box 220 is shown to include some of the edge properties in the form of key-value pairs such as the RID: ‘R1’, rule outcome node ID (denoted as “RoID” in FIG. 2): ‘RO1’, first data rule type: ‘range’, first data rule category: ‘conformity’, the first timestamp (denoted as Ro_TSP in FIG. 2): ‘A’, and the first rule outcome (denoted as “RO” in FIG. 2): ‘true’.

To associate the rule outcome node 214 with the data node 202, the processing circuitry 104 may be further configured to create an outcome-data edge 222 between the rule outcome node 214 and the data node 202. The processing circuitry 104 may be further configured to determine a set of edge attributes for the outcome-data edge 222. The set of edge attributes of the outcome-data edge 222 may include at least one of the first timestamp, an attribute value of each data attribute (e.g., the first data attribute value) of the data node 202 on which the first data rule is executed, the first rule outcome, the ID of the rule outcome node 214, the ID of the rule node 206, or the ID of the data node 202. Further, the processing circuitry 104 may be configured to associate the set of edge attributes of the outcome-data edge 222 as edge properties thereof. The edge properties of the outcome-data edge 222 are shown in a dotted box 224. The dotted box 224 is shown to include some of the edge properties in the form of key-value pairs such as NID: ‘N1’, RID: ‘R1’, RoID: ‘RO1’, Ro_TSP: ‘A’, attribute value (denoted as “Attr1V” in FIG. 2): ‘7’, and RO: ‘true’.

The scope of the present disclosure is not limited to the execution of a single rule on a data node (such as the data node 202). In numerous embodiments, two or more rules having different categories may be executed on the data node 202. All the rules associated with a data node (e.g., the data node 202) may be executed parallelly. In such a scenario, the two or more rule nodes and equivalent two or more rule outcome nodes may be created in the graph 200 in the similar manner as described above. Thus, the data node 202 may be evaluated based on different rule categories.

Although it is described that the first data rule is executed on the attribute of the data node 202, the scope of the present disclosure is not limited to it. In numerous embodiments, the first data rule may be executed on the data node 202 in entirety, without deviating from the scope of the present disclosure.

The scope of the present disclosure is not limited to the node and edge properties described above in FIG. 2. In numerous embodiments, for each node, various attributes describing characteristics thereof can be associated as node properties, whereas for each edge, any of the attributes associated as node properties of both the nodes that the edge couples, can be associated as edge properties of the edge.

The graph 200 facilitates query response generation for a system comprising the processing circuitry 104 and the storage element 106. The structure of the graph 200, especially the linking of data, rule, and rule outcome nodes, enables optimized query processing. In an embodiment, the processing circuitry 104 may receive a query to determine whether the data quality of the data node 202 meets the required standard. In the scenario illustrated in FIG. 2, as the first rule outcome is true, the response may indicate that the data quality meets the required standard. Thus, the data represented by the data node 202 may be used for various system operations. In contrast, if the first rule outcome was false, the response may indicate that the data quality is suboptimal. In such a scenario, corrective measures may be taken to improve the data quality.

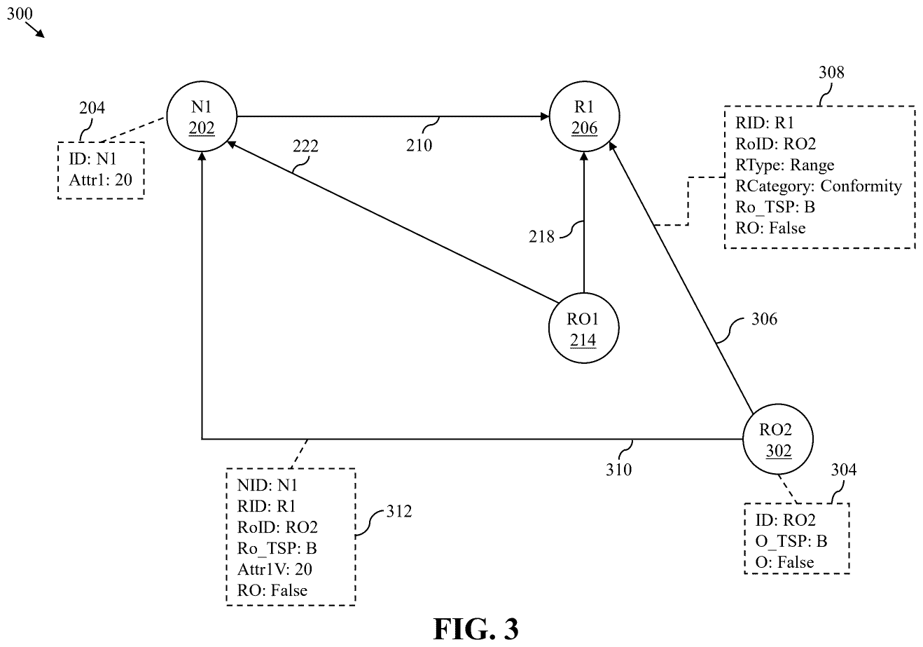

FIG. 3 is a graph 300 that illustrates rule execution at different time instances, consistent with disclosed embodiments of the present disclosure. The graph 300 may correspond to a portion of the directed property graph 110.

The graph 300 may be an extension of the graph 200, and hence, may include all the nodes (e.g., the data node 202, the rule node 206, and the rule outcome node 214) and edges (e.g., the data-rule edge 210, the outcome-rule edge 218, and the outcome-data edge 222) of the graph 200. The node properties of the rule node 206, the node properties of the rule outcome node 214, the edge properties of the data-rule edge 210, the edge properties of the outcome-rule edge 218, and the edge properties of the outcome-data edge 222 are not shown in FIG. 3 to keep the illustrations concise and clear.

The difference between the graph 300 and the graph 200 is that the attribute value of the first data attribute is different. This is shown in the dotted box 204 that includes some of the node properties of the data node 202 in the form of key-value pairs such as the ID: ‘N1’ and the first data attribute (denoted as “Attr1” in the FIG. 3): ‘20’. That is to say, the number of working hours associated with the first employee may be changed from the initial ‘7’ hours to ‘20’ hours at a later instance. In an embodiment, the change in the attribute value of the first data attribute may trigger re-execution of the first data rule.

Thus, the processing circuitry 104 may be further configured to execute the first data rule using the data node 202 to generate a second rule outcome. The second rule outcome may be generated at a second time instance indicative of a second timestamp. The execution of the first data rule at the second time instance may be similar to the execution at the first time instance. Thus, as the number of working hours (e.g., ‘20’) is outside the range of 4-8, the second rule outcome is false.

Although it is described that the execution of the first data rule using the data node 202 at the second time instance is based on the change in the attribute value of the first data attribute associated with the data node 202, the scope of the present disclosure is not limited to it. In numerous embodiments, the execution of the first data rule using the data node 202 at the second time instance may be based on a lapse of a periodic time interval, without deviating from the scope of the present disclosure.

The processing circuitry 104 may be further configured to create a rule outcome node 302 that may be indicative of the second rule outcome. Thus, the rule outcome nodes 214 and 302 are created based on the execution of the first data rule using the data node 202 at the first and second time instances, respectively. Further, the processing circuitry 104 may be configured to determine a set of outcome attributes for the rule outcome node 302. The set of outcome attributes may include at least one of a group consisting of the second timestamp or the second rule outcome. The rule outcome node 302 may have an ID associated therewith. Further, the processing circuitry 104 may be configured to associate the ID and the set of outcome attributes as node properties of the rule outcome node 302. The node properties of the rule outcome node 302 are shown within a dotted box 304 associated with the rule outcome node 302. The dotted box 304 is shown to include the node properties in the form of key-value pairs such as the ID: ‘RO2’, the second timestamp (denoted as “O_TSP” in FIG. 3): ‘B’, and the second rule outcome (denoted as ‘O’in FIG. 3): ‘false’.

The processing circuitry 104 may be further configured to associate the rule outcome node 302 with the rule node 206 and the data node 202. To associate the rule outcome node 302 with the rule node 206, the processing circuitry 104 may be further configured to create an outcome-rule edge 306 between the rule outcome node 302 and the rule node 206. The processing circuitry 104 may be further configured to determine a set of edge attributes for the outcome-rule edge 306. The set of edge attributes of the outcome-rule edge 306 may include at least one of the category of the first data rule, the type of the first data rule, the second timestamp, the second rule outcome, the ID of the rule outcome node 302, or the ID of the rule node 206. The processing circuitry 104 may be further configured to associate the set of edge attributes of the outcome-rule edge 306 as edge properties thereof. The edge properties of the outcome-rule edge 306 are shown in a dotted box 308. The dotted box 308 is shown to include some of the edge properties in the form of key-value pairs such as the RID: ‘R1’, RoID: ‘RO2’, RType: ‘range’, RCategory: ‘conformity’, the second timestamp (denoted as Ro_TSP in FIG. 3): ‘B’, and the second rule outcome (denoted as “RO” in FIG. 3): ‘false’.

To associate the rule outcome node 302 with the data node 202, the processing circuitry 104 may be further configured to create an outcome-data edge 310 between the rule outcome node 302 and the data node 202. The processing circuitry 104 may be further configured to determine a set of edge attributes for the outcome-data edge 310. The set of edge attributes of the outcome-data edge 310 may include at least one of the second timestamp, an attribute value of each data attribute (e.g., the first data attribute value) of the data node 202 on which the first data rule is executed, the second rule outcome, the ID of the rule outcome node 302, the ID of the rule node 206, or the ID of the data node 202. Further, the processing circuitry 104 may be configured to associate the set of edge attributes of the outcome-data edge 310 as edge properties thereof. The edge properties of the outcome-data edge 310 are shown in a dotted box 312. The dotted box 312 is shown to include some of the edge properties in the form of key-value pairs such as NID: ‘N1’, RID: ‘R1’, RoID: ‘RO2’, Ro_TSP: ‘B’, attribute value (denoted as “Attr1V” in FIG. 3): ‘20’, and RO: ‘false’.

The graph 300 describes the generation of different rule outcomes at different time instances thus leading to the creation of different rule outcome nodes. The structure of the graph 300, especially the association of the different rule outcome nodes that are generated at different time instances with the rule node 206 and the data node 202 may allow efficient data evaluation. For example, the processing circuitry 104 may receive a query indicative of data quality analysis of the employee dataset. To execute the query, the processing circuitry 104 may identify, in the directed property graph 110, the rule outcome nodes 214 and 302. Based on the node properties of the rule outcome nodes 214 and 302, the processing circuitry 104 may determine that the first rule outcome at the first timestamp is true, whereas the second rule outcome at the second timestamp is false. The processing circuitry 104 may thus also determine, by way of edge and node properties, that the attribute value ‘20’ of the first data attribute does not conform with the required range of 4-8. Thus, the concurrent existence of the data, rule, and rule outcome nodes in the graph 300 allows efficient quality analysis by way of efficiently identifying the area where the quality of the employee data is suboptimal.

The scope of the present disclosure is not limited to the change of attribute value being present in the same data node (e.g., the data node 502). In numerous embodiments, if the data node 202 is immutable, a clone of the data node 202 with the changed attribute value is created and the rule node 206 is associated with the clone of the data node 202 for rule execution, without deviating from the scope of the present disclosure.

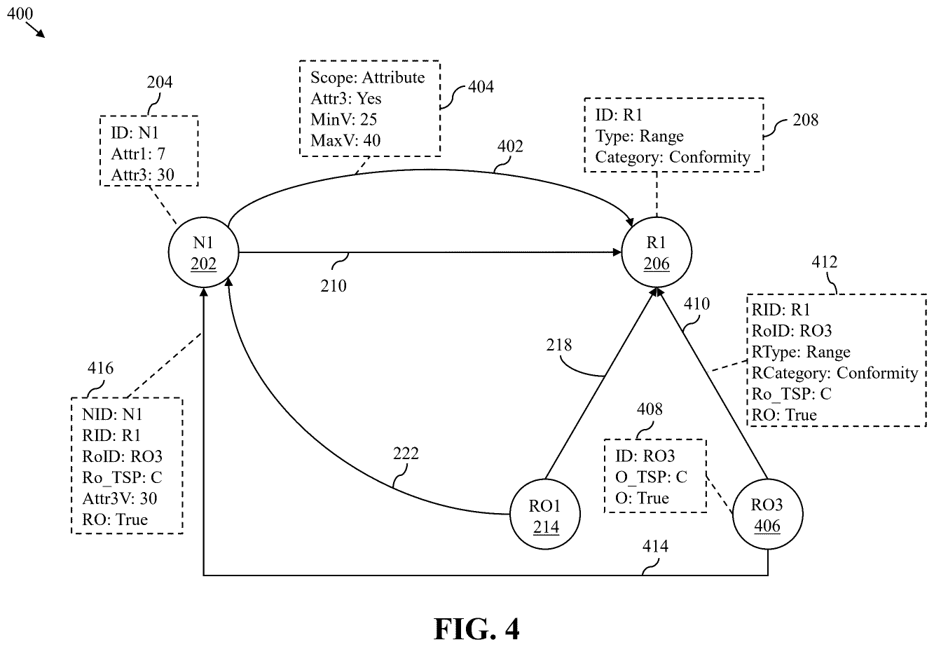

FIG. 4 is a graph 400 that illustrates execution of the same data rule on multiple data attributes, consistent with the disclosed embodiments of the present disclosure. The graph 400 may correspond to a portion of the directed property graph 110.

The graph 400 may be an extension of the graph 200, and hence, may include all the nodes (e.g., the data node 202, the rule node 206, and the rule outcome node 214) and edges (e.g., the data-rule edge 210, the outcome-rule edge 218, and the outcome-data edge 222) of the graph 200. The node properties of the rule outcome node 214, the edge properties of the data-rule edge 210, the edge properties of the outcome-rule edge 218, and the edge properties of the outcome-data edge 222 are not shown in FIG. 4 to keep the illustrations concise and clear.

The difference between the graph 400 and the graph 200 is that the first data rule is to be executed on two different data attributes of the data node 202 under two different conditions. The node properties of the data node 202 may thus include an additional data attribute. The dotted box 204 is shown to include some of the node properties of the data node 202 in the form of key-value pairs as the ID: ‘N1’, the first data attribute (denoted as “Attr1” in the FIG. 4): ‘7’, and a third data attribute (denoted as “Attr3” in the FIG. 4): ‘30’. In an example, the third data attribute may correspond to the age of the first employee.

As illustrated in FIG. 4, the processing circuitry 104 may be further configured to create another data-rule edge 402 between the data node 202 and the rule node 206 to associate the rule node 206 with the data node 202. The processing circuitry 104 may be further configured to determine a set of edge attributes for the data-rule edge 402. The set of edge attributes may include at least one of a group consisting of the scope of the first data rule, at least one data attribute (for example, the third data attribute) on which the first data rule is to be executed, one or more data attributes (for example, the second data attribute) that are excluded from the execution of the first data rule, one or more additional attributes, the ID of the data node 202, the ID of the rule node 206, the category of the first data rule, or the type of the first data rule.

The processing circuitry 104 may be further configured to associate the determined set of edge attributes as edge properties of the data-rule edge 402. The edge properties of the data-rule edge 402 are shown within a dotted box 404 associated with the data-rule edge 402. The dotted box 404 is shown to include some of the edge properties in the form of key-value pairs such as scope: ‘attribute’, Attr3: ‘Yes’, minimum value (denoted in FIG. 4 as “MinV”): ‘25’, and maximum value (denoted as “MaxV” in FIG. 4): ‘40’. In an example, if the third data attribute corresponds to the age of the first employee, the one or more additional attributes may include a minimum value of the permitted age and a maximum value of the permitted age.

Based on the association of the rule node 206 with the data node 202 via the data-rule edge 402, the processing circuitry 104 may be further configured to execute the first data rule on the attribute value of the third data attribute of the data node 202 to generate a third rule outcome. The first data rule may be executed on the attribute value of the third data attribute at a third time instance indicative of a third timestamp. Thus, in an example, the first data rule may be designed to check whether the age of the first employee being represented by the data node 202 conforms to a range of 25-40. In other words, the third rule outcome associated with the execution of the first data rule is determined based on the one or more additional attributes (e.g., the minimum and maximum values). The third rule outcome may correspond to one of a group consisting of true or false. In the example shown in FIG. 4, the third data attribute value is ‘30’. Thus, the third rule outcome is true.

The processing circuitry 104 may be further configured to create a rule outcome node 406 that may be indicative of the third rule outcome. Thus, the rule outcome nodes 214 and 406 are created based on the execution of the first data rule using the data node 202 at the first and third time instances, respectively. Further, the processing circuitry 104 may be configured to determine a set of outcome attributes for the rule outcome node 406. The set of outcome attributes may include at least one of a group consisting of the third timestamp or the third rule outcome. The rule outcome node 406 may have an ID associated therewith. Further, the processing circuitry 104 may be configured to associate the ID and the set of outcome attributes as node properties of the rule outcome node 406. The node properties of the rule outcome node 406 are shown within a dotted box 408 associated with the rule outcome node 406. The dotted box 408 is shown to include the node properties in the form of key-value pairs such as the ID: ‘RO2’, the third timestamp (denoted as “O_TSP” in FIG. 4): ‘C’, and the third rule outcome (denoted as ‘O’in FIG. 4): ‘true’.

The processing circuitry 104 may be further configured to associate the rule outcome node 406 with the rule node 206 and the data node 202. To associate the rule outcome node 406 with the rule node 206, the processing circuitry 104 may be further configured to create an outcome-rule edge 410 between the rule outcome node 406 and the rule node 206. The processing circuitry 104 may be further configured to determine a set of edge attributes for the outcome-rule edge 410. The set of edge attributes of the outcome-rule edge 410 may include at least one of the category of the first data rule, the type of the first data rule, the third timestamp, the third rule outcome, the ID of the rule outcome node 406, or the ID of the rule node 206. The processing circuitry 104 may be further configured to associate the set of edge attributes of the outcome-rule edge 410 as edge properties thereof. The edge properties of the outcome-rule edge 410 are shown in a dotted box 412. The dotted box 412 is shown to include some of the edge properties in the form of key-value pairs such as the RID: ‘R1’, RoID: ‘RO3’, first data rule type (denoted as “RType” in FIG. 4): ‘range’, first data rule category (denoted as “RCategory” in FIG. 4): ‘conformity’, the third timestamp (denoted as Ro_TSP in FIG. 4): ‘C’, and the third rule outcome (denoted as “RO” in FIG. 4): ‘true’.

To associate the rule outcome node 406 with the data node 202, the processing circuitry 104 may be further configured to create an outcome-data edge 414 between the rule outcome node 406 and the data node 202. The processing circuitry 104 may be further configured to determine a set of edge attributes for the outcome-data edge 414. The set of edge attributes of the outcome-data edge 414 may include at least one of the third timestamp, an attribute value of each data attribute (e.g., the third data attribute value) of the data node 202 on which the first data rule is executed, the third rule outcome, the ID of the rule outcome node 406, the ID of the rule node 206, or the ID of the data node 202. Further, the processing circuitry 104 may be configured to associate the set of edge attributes of the outcome-data edge 414 as edge properties thereof. The edge properties of the outcome-data edge 414 are shown in a dotted box 416. The dotted box 416 is shown to include some of the edge properties in the form of key-value pairs such as NID: ‘N1’, RID: ‘R1’, RoID: ‘RO3’, Ro_TSP: ‘C’, attribute value (denoted as “Attr3V” in FIG. 4): ‘30’, and RO: ‘true’.

The modeling of different additional attributes for data-rule edges may allow re-utilization of the same data rule. That is to say, the first data rule may be utilized for the evaluation of the data node 202 having multiple attributes under different criteria. Further, the re-utilization of the rule node 206 may ensure efficient memory utilization and may reduce computational cost.

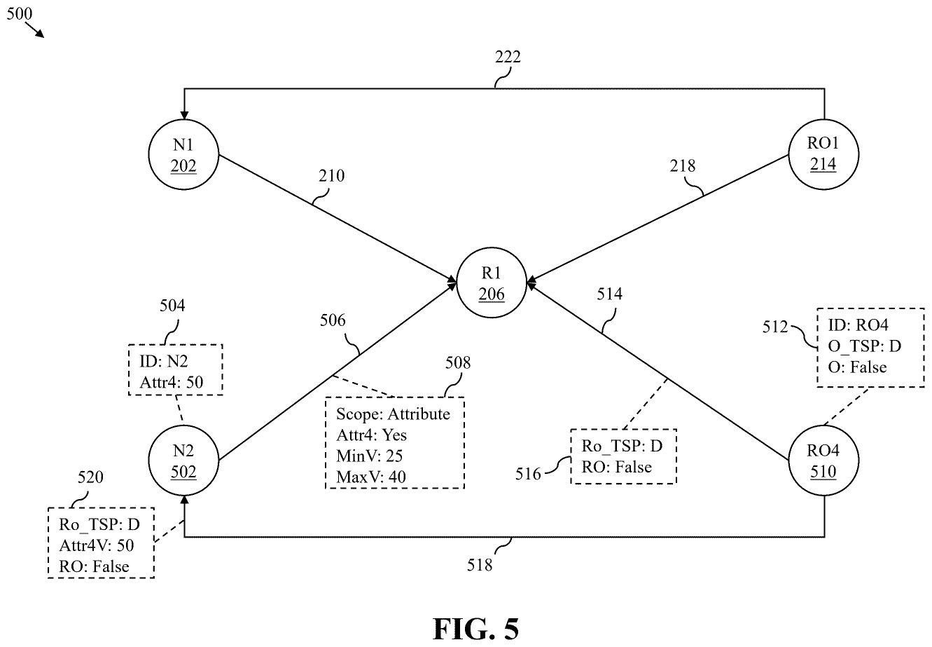

FIG. 5 is a graph 500 that illustrates sharing of a rule node between two data nodes, consistent with disclosed embodiments of the present disclosure. The graph 500 may correspond to a portion of the directed property graph 110.

The graph 500 may be an extension of the graph 200, and hence, may include all the nodes (e.g., the data node 202, the rule node 206, and the rule outcome node 214) and edges (e.g., the data-rule edge 210, the outcome-rule edge 218, and the outcome-data edge 222) of the graph 200. The node properties of the data node 202, the node properties of the rule node 206, the node properties of the rule outcome node 214, the edge properties of the data-rule edge 210, the edge properties of the outcome-rule edge 218, and the edge properties of the outcome-data edge 222 are not shown in FIG. 5 to keep the illustrations concise and clear. The difference between the graph 500 and the graph 200 is that the first data rule represented by the rule node 206 is to be executed on two different data nodes.

Thus, the processing circuitry 104 may be further configured to create a data node 502 in the graph 500. The data node 502 may represent a second data record of the dataset. In an example, the dataset may correspond to an employee dataset, and the data node 502 may represent a second employee of the employee dataset. The processing circuitry 104 may be further configured to determine a set of data attributes for the data node 502. The set of data attributes may indicate characteristics of the data node 502. In the above example, the set of data attributes may indicate characteristics of the second employee such as the name, age, address, number of working hours, or the like. Further, the data node 502 may have an ID associated therewith. The processing circuitry 104 may be further configured to associate the ID and the determined set of data attributes as node properties of the data node 502. The node properties of the data node 502 are shown within a dotted box 504 associated with the data node 502. The dotted box 504 is shown to include some of the node properties in the form of key-value pairs such as ID: ‘N2’ and a fourth data attribute (denoted as “Attr4” in the FIG. 5): ‘50’. In an example, the fourth data attribute may correspond to the age of the second employee.

The processing circuitry 104 may be further configured to identify, from the plurality of data rules, the first data rule associated with the data node 502. In other words, the first data rule is commonly associated with the data nodes 202 and 502. The processing circuitry 104 may be further configured to associate the rule node 206 with the data node 502. Thus, a common rule node (e.g., the rule node 206) is associated with the data nodes 202 and 502.

To associate the rule node 206 with the data node 502, the processing circuitry 104 may be further configured to create a data-rule edge 506 between the data node 502 with the rule node 206. The processing circuitry 104 may be further configured to determine a set of edge attributes for the data-rule edge 506. The set of edge attributes may include at least one of a group consisting of the scope of the first data rule, at least one data attribute (for example, the fourth data attribute) on which the first data rule is to be executed, one or more additional attributes, the ID of the data node 502, the ID of the rule node 206, the category of the first data rule, or the type of the first data rule. The processing circuitry 104 may be further configured to associate the determined set of edge attributes as edge properties of the data-rule edge 506. The edge properties of the data-rule edge 506 are shown within a dotted box 508 associated with the data-rule edge 506. The dotted box 508 is shown to include some of the edge properties in the form of key-value pairs such as scope: ‘attribute’, Attr4: ‘Yes’, minimum value (denoted in FIG. 5 as “MinV”): ‘25’, and maximum value (denoted as “Max V” in FIG. 5): ‘40’. In an example, if the fourth data attribute corresponds to the age of the second employee, the one or more additional attributes may include a minimum value of the permitted age and a maximum value of the permitted age.

Based on the association of the rule node 206 with the data node 502, the processing circuitry 104 may be configured to execute the first data rule to generate a fourth rule outcome. The first data rule is executed at a fourth time instance indicative of a fourth timestamp. The execution of the first data rule using the data node 502 is similar to that using the data node 202. As the attribute value of the fourth data attribute is outside the range 25-40, the fourth rule outcome is ‘false’.

The processing circuitry 104 may be further configured to create a rule outcome node 510 that may be indicative of the fourth rule outcome. The processing circuitry 104 may be further configured to determine a set of outcome attributes for the rule outcome node 510. The set of outcome attributes may include at least one of a group consisting of the fourth timestamp or the fourth rule outcome. The rule outcome node 510 may have an ID associated therewith. Further, the processing circuitry 104 may be configured to associate the ID and the set of outcome attributes as node properties of the rule outcome node 510. The node properties of the rule outcome node 510 are shown within a dotted box 512 associated with the rule outcome node 510. The dotted box 512 is shown to include some of the node properties in the form of key-value pairs such as the ID: ‘RO4’, the fourth timestamp (denoted as “O_TSP” in FIG. 5): ‘D’, and the fourth rule outcome (denoted as ‘O’in FIG. 5): ‘false’.

The processing circuitry 104 may be further configured to associate the rule outcome node 510 with the rule node 206 and the data node 502. To associate the rule outcome node 510 with the rule node 206, the processing circuitry 104 may be further configured to create an outcome-rule edge 514 between the rule outcome node 510 and the rule node 206. The processing circuitry 104 may be further configured to determine a set of edge attributes for the outcome-rule edge 514. The set of edge attributes of the outcome-rule edge 514 may include at least one of the category of the first data rule, the type of the first data rule, the fourth timestamp, the fourth rule outcome, the ID of the rule outcome node 510, or the ID of the rule node 206. The processing circuitry 104 may be further configured to associate the set of edge attributes of the outcome-rule edge 514 as edge properties thereof. The edge properties of the outcome-rule edge 514 are shown in a dotted box 516. The dotted box 516 is shown to include some of the edge properties in the form of key-value pairs such as the fourth timestamp (denoted as Ro_TSP in FIG. 5): ‘D’ and the fourth rule outcome (denoted as “RO” in FIG. 5): ‘false’.

To associate the rule outcome node 510 with the data node 502, the processing circuitry 104 may be further configured to create an outcome-data edge 518 between the rule outcome node 510 and the data node 502. The processing circuitry 104 may be further configured to determine a set of edge attributes for the outcome-data edge 518. The set of edge attributes of the outcome-data edge 518 may include at least one of the fourth timestamp, an attribute value of each data attribute (e.g., the fourth data attribute value) of the data node 502 on which the first data rule is executed, the fourth rule outcome, the ID of the rule outcome node 510, the ID of the rule node 206, or the ID of the data node 502. Further, the processing circuitry 104 may be configured to associate the set of edge attributes of the outcome-data edge 518 as edge properties thereof. The edge properties of the outcome-data edge 518 are shown in a dotted box 520. The dotted box 520 is shown to include some of the edge properties in the form of key-value pairs such Ro_TSP: ‘D’, attribute value (denoted as “Attr4V” in FIG. 5): ‘50’, and RO: ‘false’.

Although not shown, each of the data nodes 202 and 502 may have other associated data rules which may be executed in a similar manner as the execution of the first data rule on the data node 202. Further, any other common data rule between the data nodes 202 and 502 may be executed in a similar manner as described in FIG. 5.

The graph 500 illustrated in FIG. 5 describes the association between the data nodes and the common rule node. The structure of the graph 500, especially the execution of different attributes of different data nodes by utilizing the common rule node may allow efficient memory utilization.

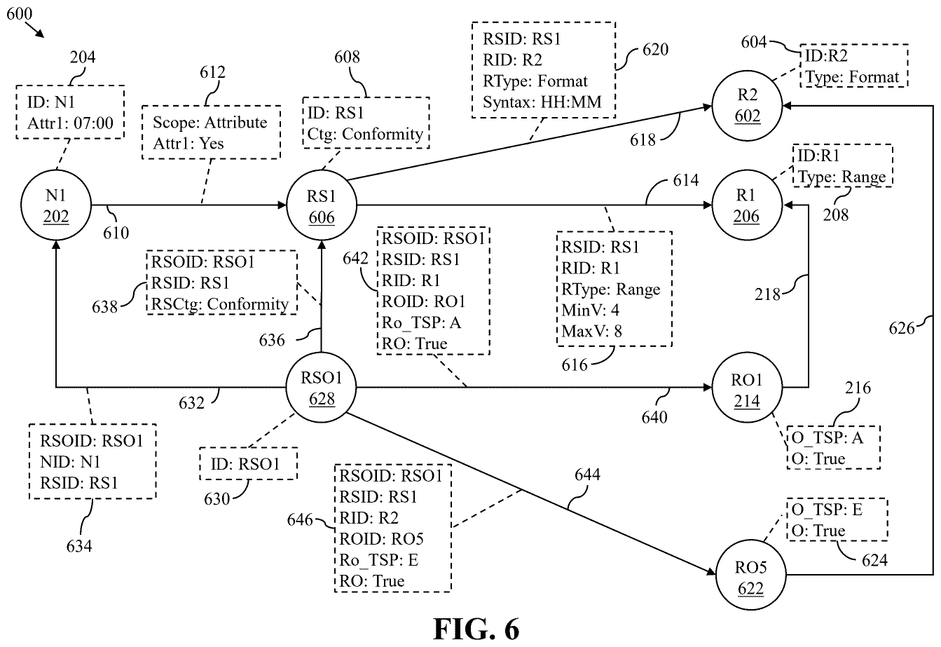

FIG. 6 is a graph 600 that illustrates association between data nodes, ruleset nodes, and outcome-set nodes, consistent with disclosed embodiments of the present disclosure. The graph 600 may correspond to a portion of the directed property graph 110.

The graph 200 of FIG. 2 describes the execution of one data rule on a data node (e.g., the data node 202). In such cases, if there are two or more data rules having the same category, all such data rules can be executed on the data node 202 by way of a ruleset node. Further, for each rule execution, a corresponding rule outcome and a corresponding rule outcome node may be created. Since these two or more rule outcome nodes are outcomes of the same rule category, an outcome-set node may be created to link these rule outcome nodes. Such a graph structure is described in FIG. 6. The creation of the data nodes, rule nodes, outcome nodes, data-rule edges, outcome-rule edges, and outcome-data edges remain the same as described in FIG. 2 and are described in brief in FIG. 6.

As illustrated in FIG. 6, the processing circuitry 104 may be configured to create the data node 202 in the similar manner described in FIG. 2. The processing circuitry 104 may be further configured to associate a set of data attributes as node properties of the data node 202. The node properties of the data node 202 are shown within the dotted box 204 associated with the data node 202. The dotted box 204 may include some of the node properties in the form of key-value pairs such as ID: ‘N1’ and an attribute value of the first data attribute (denoted as “Attr1” in FIG. 6): ‘07:00’.

The processing circuitry 104 may be further configured to identify the first set of data rules associated with the data node 202. The first set of data rules may include the first data rule and a second data rule. The first data rule and the second data rule may be associated with the conformity category. Further, the first data rule may be a range rule type, whereas the second data rule may have a format rule type. The first data rule is hereinafter referred to as the “range data rule”, whereas the second data rule is hereinafter referred to as the “format data rule”. The processing circuitry 104 may be further configured to create the rule node 206 indicative of the range data rule and a rule node 602 indicative of the format data rule. Further, the processing circuitry 104 may be configured to associate an ID and a rule type of the range data rule as node properties of the rule node 206. Similarly, the processing circuitry 104 may be further configured to associate an ID and the rule type of the format data rule as node properties of the rule node 602. The dotted box 208 shows some of the node properties of the rule node 206 in the form of key-value pairs such as ID: ‘R1’ and type: ‘range’. Similarly, a dotted box 604 shows some of the node properties of the rule node 602 in the form of key-value pairs such as ID: ‘R2’ and type: ‘format’.

The processing circuitry 104 may be further configured to associate the rule node 206 and the rule node 602 with the data node 202. In an embodiment, to associate the rule nodes 206 and 602 with the data node 202, the processing circuitry 104 may be further configured to create a ruleset node 606 for the first set of rules (e.g., the first and second data rules). In other words, as the first and second data rules have the same category, the first and second data rules can be combined into a ruleset indicated by the ruleset node 606. The ruleset node 606 may thus be associated with an ID and the conformity category. The processing circuitry 104 may be further configured to associate the ID and the category of the first set of data rules as node properties of the ruleset node 606. The node properties of the ruleset node 606 are shown to be included in a dotted box 608 associated with the ruleset node 606. The dotted box 608 is shown to include some node properties in the form of key-value pairs such as the ruleset node ID (denoted as “RSID” in FIG. 6): ‘RS1’ and category (denoted as “Ctg” in FIG. 6): ‘conformity’.

The processing circuitry 104 may be further configured to create a data-ruleset edge 610 between the data node 202 and the ruleset node 606. The processing circuitry 104 may be further configured to associate a set of edge attributes as edge properties of the data-ruleset edge 610. The set of edge attributes of the data-ruleset edge 610 may comprise a scope of the first set of data rules and at least one data attribute of the data node 202 on which the first set of data rules is to be executed. The edge properties of the data-ruleset edge 610 are shown within a dotted box 612 associated with the data-ruleset edge 610. The dotted box 612 is shown to include some of the edge properties in the form of key-value pairs such as the scope: ‘attribute’ and Attr1: ‘Yes’. In an embodiment, the first data attribute may correspond to a number of working hours of the first employee, and may have an attribute value: ‘07:00’.

The processing circuitry 104 may be further configured to create a ruleset-rule edge 614 between the ruleset node 606 and the rule node 206. Further, the processing circuitry 104 may be configured to associate a set of edge attributes as edge properties of the ruleset-rule edge 614. The set of edge attributes may comprise at least one of the ID of the ruleset node 606, the ID of the rule node 206, the type of the first data rule, or one or more additional attributes defining a criterion associated with the execution of the first data rule. The edge properties of the ruleset-rule edge 614 are shown within a dotted box 616 associated with the ruleset-rule edge 614. The dotted box 616 is shown to include some of the edge properties in the form of key-value pairs such as the RSID: ‘RS1’, rule node ID (denoted as “RID” in FIG. 6): ‘R1’, rule type (denoted as “RType” in FIG. 6): ‘range’, a minimum value for the number of permitted working hours (denoted in FIG. 6 as “MinV”): ‘4’, and a maximum value for the number of permitted working hours (denoted in FIG. 6 as “Max V”): ‘8’.

Similarly, the processing circuitry 104 may be further configured to create a ruleset-rule edge 618 between the ruleset node 606 and the rule node 602. Further, the processing circuitry 104 may be configured to associate a set of edge attributes as edge properties of the ruleset-rule edge 618. The set of edge attributes may comprise at least one of the ID of the ruleset node 606, the ID of the rule node 602, the type of the second data rule, or one or more additional attributes defining a criterion associated with the execution of the second data rule. The edge properties of the ruleset-rule edge 618 are shown within a dotted box 620 associated with the ruleset-rule edge 618. The dotted box 620 is shown to include some of the edge properties in the form of key-value pairs such as the RSID: ‘RS1’, RID: ‘R2’, RType: ‘format’, and a syntax of the working hours (denoted in FIG. 6 as “Syntax”): ‘HH:MM’.

Based on the association of the ruleset node 606 with the data node 202, the processing circuitry 104 may be configured to execute the first set of data rules on the attribute value of the first data attribute included in the edge properties of the data-ruleset edge 610. Further, a first set of rule outcomes is generated based on the execution of the first set of data rules on the attribute value of the first data attribute. The first set of rule outcomes may include a rule outcome of the range rule type (hereinafter referred to as the “range rule outcome”) and a rule outcome of the format rule type (hereinafter referred to as the “format rule outcome”). The range rule outcome is generated based on the execution of the range data rule on the attribute value of the first data attribute, whereas the format rule outcome is generated based on the execution of the format data rule on the attribute value of the first data attribute. The range rule outcome is determined based on the one or more additional attributes associated as the edge properties of the ruleset-rule edge 614. Thus, as the range defined in the edge properties of the ruleset-rule edge 614 is 4-8 and the attribute value of the first data attribute is ‘7’, the range rule outcome is ‘true’. Similarly, the format rule outcome is determined based on the one or more additional attributes that are associated as the edge properties of the ruleset-rule edge 618. Thus, as the syntax defined in the edge properties of the ruleset-rule edge 618 is ‘HH:MM’, and the attribute value of the first data attribute is ‘07:00’, the format rule outcome is ‘true’.

The processing circuitry 104 may be configured to create the rule outcome node 214 representing the range rule outcome and a rule outcome node 622 representing the format rule outcome. Further, the processing circuitry 104 may be configured to associate the corresponding set of outcome attributes as node properties of the rule outcome nodes 214 and 622. The node properties of the rule outcome node 214 may include the first timestamp associated with the execution of the range data rule on the data node 202 and the range rule outcome. Similarly, the node properties of the rule outcome node 622 may include a fifth timestamp associated with the execution of the format data rule on the data node 202 and the format rule outcome. The node properties of the rule outcome nodes 214 and 622 are shown within dotted boxes 216 and 624, respectively. The dotted box 216 is shown to include some node properties in the form of key-value pairs such as the timestamp (denoted as “O_TSP” in FIG. 6): ‘A’, and range rule outcome (denoted as ‘O’ in FIG. 6): ‘true’. Similarly, the dotted box 624 is shown to include some node properties in the form of key-value pairs such as O_TSP: ‘E’and O: ‘true’.

The processing circuitry 104 may be further configured to associate the rule outcome nodes 214 and 622 with the rule nodes 206 and 602 by way of the outcome-rule edge 218 and an outcome-rule edge 626, respectively, in a similar manner as described in FIG. 2. The edge properties of the outcome-rule edges are not described and illustrated in FIG. 6 to keep the description and illustration concise and clear.

The processing circuitry 104 may be further configured to associate the rule outcome nodes 214 and 622 with the rule nodes 206 and 602 and the data node 202. To associate the rule outcome nodes 214 and 622 with the rule nodes 206 and 602 and the data node 202, the processing circuitry 104 may be further configured to create an outcome-set node 628 for the first set of rule outcomes. The outcome-set node 628 may be associated with an ID. The processing circuitry 104 may be further configured to associate the ID of the outcome-set node 628 as the node properties thereof. A dotted box 630, associated with the outcome-set node 628, may illustrate the ID as a key-value pair (e.g., ID: ‘RSO1’).

The processing circuitry 104 may be further configured to create an outcome-set-data edge 632 between the outcome-set node 628 and the data node 202. The processing circuitry 104 may be further configured to associate a set of edge attributes as edge properties of the outcome-set-data edge 632. The edge properties of the outcome-set-data edge 632 are shown within a dotted box 634. The dotted box 634 is shown to include some of the edge properties in the form of key-value pairs such as outcome-set node ID (denoted as “RSOID” in FIG. 6): ‘RSO1’, node ID: ‘N1’, and RSID: ‘RS1’.

The processing circuitry 104 may be further configured to create an outcome-set-ruleset edge 636 between the outcome-set node 628 and the ruleset node 606. The processing circuitry 104 may be further configured to associate a set of edge attributes as edge properties of the outcome-set-ruleset edge 636. The edge properties of the outcome-set-ruleset edge 636 are shown within a dotted box 638. The dotted box 638 is shown to include some of the edge properties in the form of key-value pairs such as RSOID: ‘RSO1’, RSID: ‘RS1’, and ruleset category (denoted as “RSCtg” in FIG. 6): ‘conformity’.

The processing circuitry 104 may be further configured to create a set of outcome-set-outcome edges between the outcome-set node 628 and the first set of rule outcome nodes (for example, the rule outcome nodes 214 and 622). For example, the processing circuitry 104 may be configured to create an outcome-set-outcome edge 640 between the outcome-set node 628 and the rule outcome node 214. The processing circuitry 104 may be further configured to associate a set of edge attributes as edge properties of the outcome-set-outcome edge 640. The edge properties of the outcome-set-outcome edge 640 are shown within a dotted box 642. The dotted box 642 is shown to include some of the edge properties in the form of key-value pairs such as RSOID: ‘RSO1’, RSID: ‘RS1’, RID: ‘R1’, ROID: ‘RO1’, Ro_TSP: ‘A’, and RO: ‘true’. Similarly, the processing circuitry 104 may be configured to create an outcome-set-outcome edge 644 between the outcome-set node 628 and the rule outcome node 622. The processing circuitry 104 may be further configured to associate a set of edge attributes as edge properties of the outcome-set-outcome edge 644. The edge properties of the outcome-set-outcome edge 644 are shown within a dotted box 646. The dotted box 646 is shown to include some of the edge properties in the form of key-value pairs such as RSOID: ‘RSO1’, RSID: ‘RS1’, RID: ‘R2’, ROID: ‘RO5’, Ro_TSP: ‘E’, and RO: ‘true’.

Thus, modeling of the ruleset node 606 may allow efficient identification of the required data rules for execution thereof. Further, modeling of the outcome-set node 628 may allow efficient identification of the rule outcomes for data quality analysis.

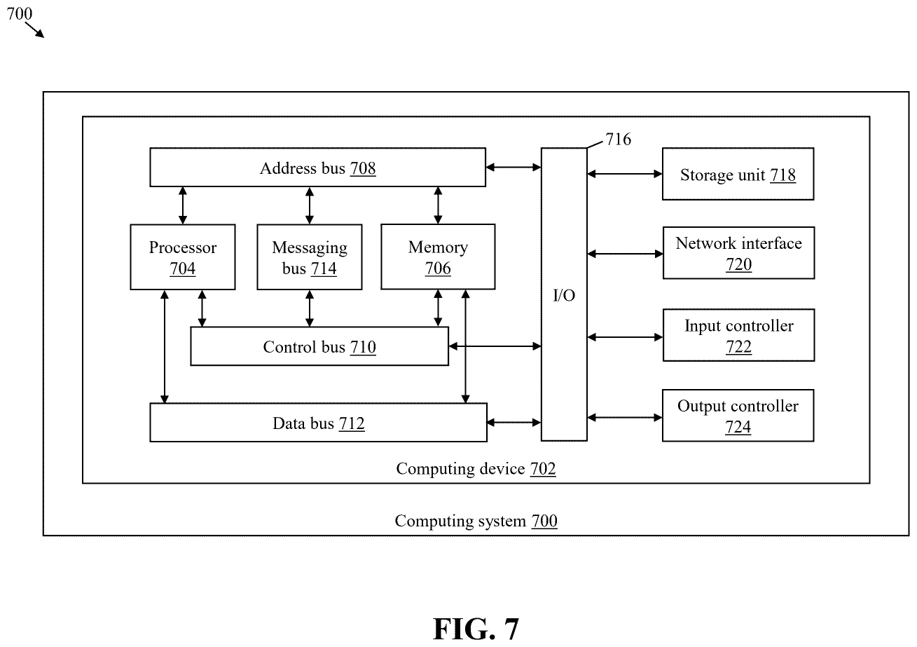

FIG. 7 illustrates an example computing system 700 for carrying out the methods of the present disclosure, consistent with disclosed embodiments of the present disclosure. Specifically, FIG. 7 shows a block diagram of an embodiment of the computing system 700 according to example embodiments of the present disclosure.

The computing system 700 may be configured to perform any of the operations disclosed herein. The computing system 700 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 700 is a distributed system configured to function using multiple computing machines interconnected via a data network or bus system.

The computing system 700 includes computing devices (such as a computing device 702). The computing device 702 includes one or more processors (such as a processor 704) and a memory 706. The processor 704 may be any general-purpose processor(s) configured to execute a set of instructions. For example, the processor 704 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 704 may be multiple processing units, a single processing core, multiple processing cores, special purpose processing cores, co-processors, or any combination thereof. The processor 704 may be communicatively coupled to the memory 706 via an address bus 708, a control bus 710, a data bus 712, and a messaging bus 714.

The memory 706 may include non-volatile memories such as a read-only memory (ROM), a programable read-only memory (PROM), an erasable programmable read-only memory (EPROM), a flash memory, or any other device capable of storing program instructions or data with or without applied power. The memory 706 may also include volatile memories, such as a random-access memory (RAM), a static random-access memory (SRAM), a dynamic random-access memory (DRAM), and a synchronous dynamic random-access memory (SDRAM). The memory 706 may include single or multiple memory modules. While the memory 706 is depicted as part of the computing device 702, a person skilled in the art will recognize that the memory 706 can be separate from the computing device 702.

The memory 706 may store information that can be accessed by the processor 704. For instance, the memory 706 (e.g., one or more non-transitory computer-readable storage mediums, memory devices) may include computer-readable instructions (not shown) that can be executed by the processor 704. The computer-readable instructions may be software written in any suitable programming language or may be implemented in hardware. Additionally, or alternatively, the computer-readable instructions may be executed in logically and/or virtually separate threads on the processor 704. For example, the memory 706 may store instructions (not shown) that when executed by the processor 704 cause the processor 704 to perform operations such as any of the operations and functions for which the computing system 700 is configured, as described herein. Additionally, or alternatively, the memory 706 may store data (not shown) that can be obtained, received, accessed, written, manipulated, created, and/or stored. The data can include, for instance, the data and/or information described herein in relation to FIGS. 1-6. In some implementations, the computing device 702 may obtain from and/or store data in one or more memory device(s) that are remote from the computing system 700.

The computing device 702 may further include an input/output (I/O) interface 716 communicatively coupled to the address bus 708, the control bus 710, and the data bus 712. The data bus 712 and messaging bus 714 may include a plurality of tunnels that may support parallel processing of messages. The I/O interface 716 is configured to couple to one or more external devices (e.g., to receive and send data from/to one or more external devices). Such external devices, along with the various internal devices, may also be known as peripheral devices. The I/O interface 716 may include both electrical and physical connections for operably coupling the various peripheral devices to the computing device 702. The I/O interface 716 may be configured to communicate data, addresses, and control signals between the peripheral devices and the computing device 702. The I/O interface 716 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 716 is configured to implement only one interface or bus technology. Alternatively, the I/O interface 716 is configured to implement multiple interfaces or bus technologies. The I/O interface 716 may include one or more buffers for buffering transmissions between one or more external devices, internal devices, the computing device 702, or the processor 704. The I/O interface 716 may couple the computing device 702 to various input devices, including mice, touch screens, scanners, biometric readers, electronic digitizers, sensors, receivers, touchpads, trackballs, cameras, microphones, keyboards, any other pointing devices, or any combinations thereof. The I/O interface 716 may couple the computing device 702 to various output devices, including video displays, speakers, printers, projectors, tactile feedback devices, automation control, robotic components, actuators, motors, fans, solenoids, valves, pumps, transmitters, signal emitters, lights, and so forth.

The computing system 700 may further include a storage unit 718, a network interface 720, an input controller 722, and an output controller 724. The storage unit 718, the network interface 720, the input controller 722, and the output controller 724 are communicatively coupled to the central control unit (e.g., the memory 706, the address bus 708, the control bus 710, and the data bus 712) via the I/O interface 716. The network interface 720 communicatively couples the computing system 700 to one or more networks such as wide area networks (WAN), local area networks (LAN), intranets, the Internet, wireless access networks, wired networks, mobile networks, telephone networks, optical networks, or combinations thereof. The network interface 720 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 718 is a computer-readable medium, preferably a non-transitory computer-readable medium, comprising one or more programs, the one or more programs comprising instructions which when executed by the processor 704 cause the computing system 700 to perform the method steps of the present disclosure. Alternatively, the storage unit 718 is a transitory computer-readable medium. The storage unit 718 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 718 stores one or more operating systems, application programs, program modules, data, or any other information. The storage unit 718 is part of the computing device 702. Alternatively, the storage unit 718 is part of one or more other computing machines that are in communication with the computing device 702, such as servers, database servers, cloud storage, network attached storage, and so forth.

The input controller 722 may include suitable logic, circuitry, interfaces, and/or code, executable by the circuitry, that may be configured to control one or more input devices that may be configured to receive an input (e.g., the data analysis query) generated by the real-time system 102. The output controller 724 may include suitable logic, circuitry, interfaces, and/or code, executable by the circuitry, that may be configured to control one or more output devices that may be configured to render/output the outcome of the operation executed to process the received input.

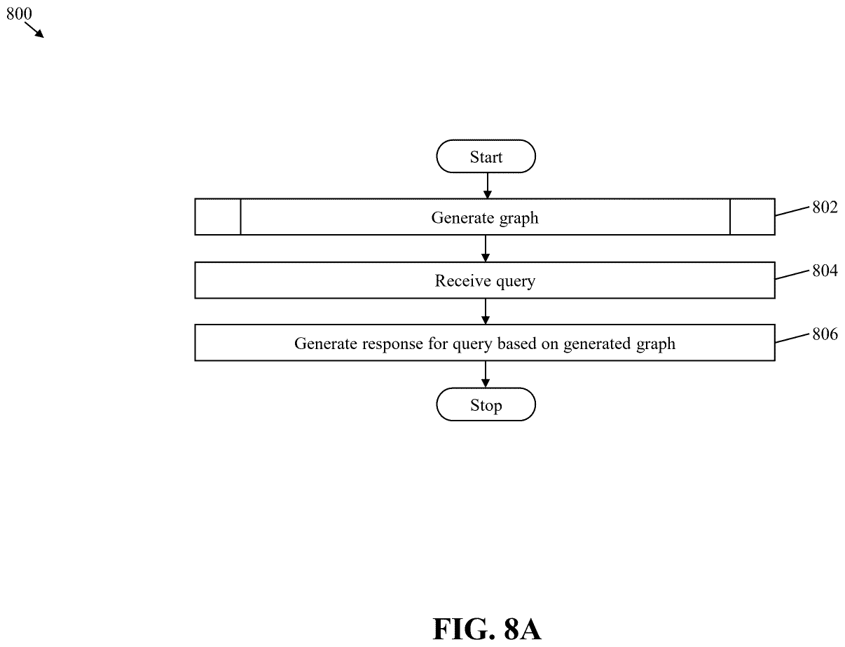

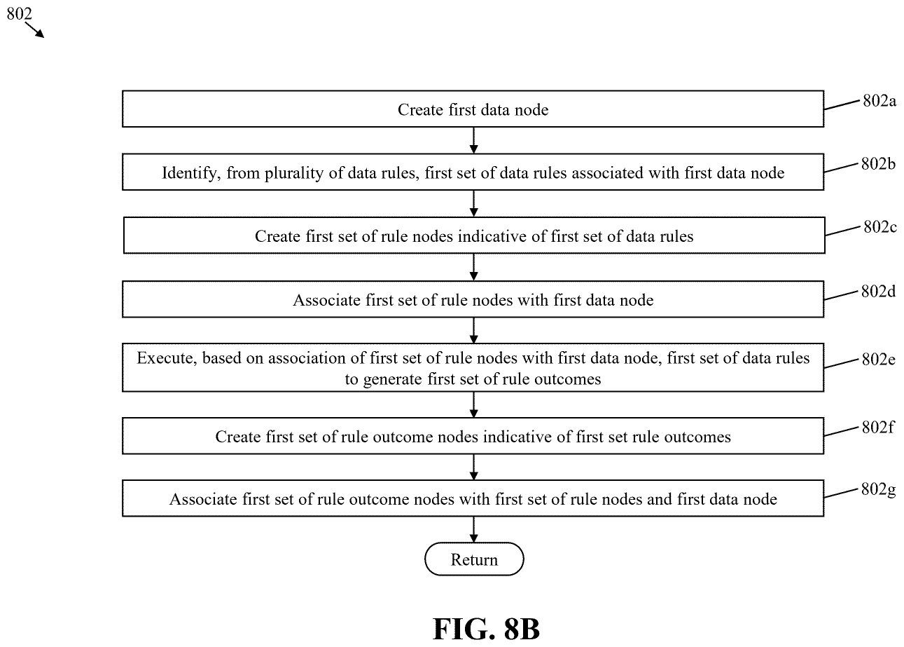

FIGS. 8A and 8B, collectively, represents a flowchart 800 that illustrates a method for facilitating rule engine using directed property graphs, consistent with disclosed embodiments of the present disclosure.

Referring to FIG. 8A, at 802, the processing circuitry 104 may generate a graph (e.g., the directed property graph 110). The generated graph may facilitate query response generation. The generation of the graph is explained in conjunction with FIG. 8B.

Referring to FIG. 8B, to generate the graph, at 802a, the processing circuitry 104 may create a first data node. At 802b, the processing circuitry 104 may identify, from a plurality of data rules, a first set of data rules associated with the first data node. At 802c, the processing circuitry 104 may create a first set of rule nodes indicative of the first set of data rules. At 802d, the processing circuitry 104 may associate the first set of rule nodes with the first data node. At 802e, the processing circuitry 104 may execute, based on the association of the first set of rule nodes with the first data node, the first set of data rules to generate a first set of rule outcomes. At 802f, the processing circuitry 104 may create a first set of rule outcome nodes indicative of the first set of rule outcomes. At 802g, the processing circuitry 104 may associate the first set of rule outcome nodes with the first set of rule nodes and the first data node.

Referring back to FIG. 8A, at 804, the processing circuitry 104 may receive a query. The query may be generated by the real-time system 102. At 806, the processing circuitry 104 may generate a response for the query based on the generated graph.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for rule engine using directed property graphs. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. A system, comprising:
   processing circuitry configured to generate a graph based on a plurality of data rules,
      wherein to generate the graph, the processing circuitry is further configured to:
         create a first data node;
         identify, from the plurality of data rules, a first set of data rules associated with the first data node;
         create a first set of rule nodes indicative of the first set of data rules;
         associate the first set of rule nodes with the first data node;
         execute, based on the association of the first set of rule nodes with the first data node, the first set of data rules to generate a first set of rule outcomes;
         create a first set of rule outcome nodes indicative of the first set of rule outcomes; and
         associate the first set of rule outcome nodes with the first set of rule nodes and the first data node, and
      wherein the generated graph facilitates query response generation.
2. The system of 1, wherein a data rule, of the plurality of data rules, adheres to one of a group consisting of completeness, uniqueness, consistency, accuracy, or conformity.
3. The system of 1, wherein to associate the first set of rule nodes with the first data node, the processing circuitry is further configured to create a set of data-rule edges between the first data node and the first set of rule nodes, with a data-rule edge being created between the first data node and a first rule node of the first set of rule nodes.
4. The system of 3, wherein the processing circuitry is further configured to:
   determine, for the first data node, a first set of data attributes that indicates characteristics of the first data node;
   determine, for the first rule node, a first set of rule attributes that comprises at least one of a group consisting of (i) a category of a first data rule, of the first set of data rules, indicated by the first rule node or (ii) a type of the first data rule;
   determine, for the data-rule edge, a set of edge attributes that comprises at least one of a group consisting of (i) a scope of the first data rule, (ii) at least one data attribute, of the first set of data attributes, on which the first data rule is to be executed, or (iii) one or more additional attributes defining a criterion associated with the execution of the first data rule; and
   associate the first set of data attributes as node properties of the first data node, the first set of rule attributes as node properties of the first rule node, and the set of edge attributes as edge properties of the data-rule edge.
5. The system of 4, wherein the set of edge attributes of the data-rule edge further comprises one or more data attributes, of the first set of data attributes, that are excluded from the execution of the first data rule.
6. The system of 4, wherein the scope of the first data rule indicates whether the first data rule is to be executed on the first data node in entirety or on a data attribute of the first data node.
7. The system of 4,
   wherein the first data rule is executed on an attribute value of the at least one data attribute included in the set of edge attributes, and
   wherein a first rule outcome, of the first set of rule outcomes, associated with the execution of the first data rule is determined based on the one or more additional attributes.
8. The system of 4, wherein the set of edge attributes of the data-rule edge further comprises an identifier of the first data node, an identifier of the first rule node, the category of the first data rule, and the type of the first data rule.
9. The system of 4, wherein the category of the first data rule corresponds to one of a group consisting of completeness, uniqueness, consistency, accuracy, or conformity.
10. The system of 1, wherein each of the first set of rule outcomes corresponds to one of a group consisting of true or false.
11. The system of 1, wherein the first set of rule outcomes is indicative of evaluation of the first data node based on a set of data analysis parameters associated with the first set of data rules.
12. The system of 11, wherein a data analysis parameter, of the set of data analysis parameters, corresponds to one of a group consisting of a completeness parameter, a uniqueness parameter, a consistency parameter, an accuracy parameter, and a conformity parameter.
13. The system of 1, wherein to associate the first set of rule outcome nodes with the first set of rule nodes and the first data node, the processing circuitry is further configured to:
   create a set of outcome-rule edges between the first set of rule outcome nodes and the first set of rule nodes, with an outcome-rule edge being created between a first rule outcome node, of the first set of rule outcome nodes, and a first rule node, of the first set of rule nodes; and
   create a set of outcome-data edges between the first set of rule outcome nodes and the first data node, with an outcome-data edge being created between the first rule outcome node and the first data node.
14. The system of 13, wherein the processing circuitry is further configured to:
   determine, for the first rule outcome node, a first set of outcome attributes that comprises at least one of a group consisting of (i) a first timestamp associated with the execution of a first data rule, of the first set of data rules, indicated by the first rule node, using the first data node, or (ii) a first rule outcome, of the first set of rule outcomes, associated with the execution of the first data rule; and
   associate the first set of outcome attributes as node properties of the first rule outcome node.
15. The System of 13,
   wherein for the outcome-rule edge, the processing circuitry is further configured to determine a set of edge attributes that comprises (i) a category of a first data rule, of the first set of data rules, indicated by the first rule node, (ii) a type of the first data rule, (iii) a first timestamp associated with the execution of the first data rule using the first data node, or (iv) a first rule outcome, of the first set of rule outcomes, associated with the execution of the first data rule, and associate the determined set of edge attributes as edge properties thereof, and
   wherein for the outcome-data edge, the processing circuitry is further configured to determine another set of edge attributes that comprises (i) the first timestamp, (ii) an attribute value of each data attribute, of the first data node, on which the first data rule is executed, or (iii) the first rule outcome, and associate the determined set of edge attributes as edge properties thereof.
16. The system of 15,
   wherein the set of edge attributes of the outcome-rule edge further comprises an identifier of the first rule node and an identifier of the first rule outcome node, and
   wherein the set of edge attributes of the outcome-data edge further comprises an identifier of the first data node, the identifier of the first rule node, and the identifier of the first rule outcome node.
17. The system of 1, wherein the processing circuitry is further configured to associate:
   an identifier of the first data node as node properties of the first data node,
   an identifier of a first rule node, of the first set of rule nodes, as node properties of the first rule node, and
   an identifier of a first rule outcome node, of the first set of rule outcome nodes, as node properties of the first rule outcome node.
18. The system of 1,
   wherein a first rule outcome node, of the first set of rule outcome nodes, is created based on an execution of a first data rule, of the first set of data rules, indicated by a first rule node, of the first set of rule nodes, using the first data node at a first time instance, and
   wherein a second rule outcome node, of the first set of rule outcome nodes, is created based on the execution of the first data rule using the first data node at a second time instance.
19. The system of 18, wherein to associate the first set of rule outcome nodes with the first set of rule nodes and the first data node, the processing circuitry is further configured to:
   create a first outcome-rule edge between the first rule outcome node and the first rule node, wherein node properties of the first rule outcome node comprise at least one of a group consisting of (i) a first timestamp indicative of the first time instance or (ii) a first rule outcome, of the first set of rule outcomes, associated with the execution of the first data rule using the first data node at the first time instance; and
   create a first outcome-data edge between the first rule outcome node and the first data node, wherein edge properties of the first outcome-data edge comprise at least one of a group consisting of (i) the first timestamp, (ii) an attribute value, associated with the first data node, on which the first data rule is executed at the first time instance, or (iii) the first rule outcome.
20. The system of 18, wherein to associate the first set of rule outcome nodes with the first set of rule nodes and the first data node, the processing circuitry is further configured to:
   create a second outcome-rule edge between the second rule outcome node and the first rule node, wherein node properties of the second rule outcome node comprise at least one of a group consisting of (i) a second timestamp indicative of the second time instance, or (ii) a second rule outcome, of the first set of rule outcomes, associated with the execution of the first data rule using the first data node at the second time instance; and
   create a second outcome-data edge between the second rule outcome node and the first data node, wherein edge properties of the second outcome-data edge comprise at least one of a group consisting of (i) the second timestamp, (ii) an attribute value, associated with the first data node, on which the first data rule is executed at the second time instance, or (iii) the second rule outcome.
21. The system of 18, wherein the execution of the first data rule using the first data node at the second time instance is based on a change in an attribute value associated with the first data node.
22. The system of 18, wherein the execution of the first data rule using the first data node at the second time instance is based on a lapse of a periodic time interval.
23. The system of 1,
   wherein to associate a first rule node, of the first set of rule nodes, with the first data node, the processing circuitry is further configured to create a first data-rule edge and a second data-rule edge between the first data node and the first rule node,
   wherein edge properties of the first data-rule edge comprise at least one of a group consisting of (i) a category of a first data rule, of the first set of data rules, indicated by the first rule node, (ii) a type of the first data rule, (iii) a scope of the first data rule, (iv) a first data attribute of the first data node on which the first data rule is to be executed, or (v) a first set of additional attributes defining a first criterion associated with the execution of the first data rule, and
   wherein edge properties of the second data-rule edge comprise at least one of a group consisting of (i) the category of the first data rule, (ii) the type of the first data rule, (iii) the scope of the first data rule, (iv) a second data attribute of the first data node on which the first data rule is to be executed, or (v) a second set of additional attributes defining a second criterion associated with the execution of the first data rule.
24. The system of 23,
   wherein (i) the first data rule is executed on a first attribute value of the first data attribute at a first time instance, (ii) a first rule outcome, of the first set of rule outcomes, associated with the execution of the first data rule on the first attribute value is determined based on the first set of additional attributes, and (iii) a first rule outcome node, of the first set of rule outcome nodes, indicates the first rule outcome, and
   wherein (i) the first data rule is executed on a second attribute value of the second data attribute at a second time instance, (ii) a second rule outcome, of the first set of rule outcomes, associated with the execution of the first data rule on the second attribute value is determined based on the second set of additional attributes, and (iii) a second rule outcome node, of the first set of rule outcome nodes, indicates the second rule outcome.
25. The system of 24, wherein to associate the first set of rule outcome nodes with the first set of rule nodes and the first data node, the processing circuitry is further configured to:
   create a first outcome-rule edge between the first rule outcome node and the first rule node, wherein node properties of the first rule outcome node comprise at least one of the first rule outcome or a first timestamp indicative of the first time instance;
   create a first outcome-data edge between the first rule outcome node and the first data node, wherein edge properties of the first outcome-data edge comprise at least one of the first timestamp, the first attribute value, or the first rule outcome;
   create a second outcome-rule edge between the second rule outcome node and the first rule node, wherein node properties of the second rule outcome node comprise at least one of the second rule outcome or a second timestamp indicative of the second time instance; and
   create a second outcome-data edge between the second rule outcome node and the first data node, wherein edge properties of the second outcome-data edge comprise at least one of the second timestamp, the second attribute value, or the second rule outcome.
26. The system of 1, wherein to generate the graph, the processing circuitry is further configured to:
   create a second data node;
   identify, from the plurality of data rules, a second set of data rules associated with the second data node, wherein the first set of data rules and the second set of data rules have at least one common data rule;
   associate, with the second data node, a common rule node, of the first set of rule nodes, that indicates the at least one common data rule, wherein based on the association of the common rule node with the second data node, the at least one common data rule is executed using the second data node to generate another rule outcome;
   create another rule outcome node indicative of the other rule outcome generated based on the execution of the at least one common data rule using the second data node; and
   associate the other rule outcome node with the common rule node and the second data node.
27. The system of 1, wherein the processing circuitry executes the first set of data rules further based on a change associated with the system.
28. The system of 1, wherein to associate the first set of rule nodes with the first data node, the processing circuitry is further configured to:
   create a ruleset node for the first set of data rules;
   create a data-ruleset edge between the first data node and the ruleset node; and
   create a set of ruleset-rule edges between the ruleset node and the first set of rule nodes, with a ruleset-rule edge being created between the ruleset node and a first rule node of the first set of rule nodes.
29. The system of 28, wherein the processing circuitry is further configured to:
   associate, as node properties of the first data node, a first set of data attributes that indicates characteristics of the first data node;
   associate, as node properties of the ruleset node, a category of the first set of data rules;
   associate, as node properties of the first rule node, a type of a first data rule indicated by the first rule node;
   associate, as edge properties of the data-ruleset edge, at least one data attribute, of the first set of data attributes, on which the first set of data rules is to be executed; and
   associate, as edge properties of the ruleset-rule edge, one or more additional attributes defining a criterion associated with the execution of the first data rule.
30. The system of 29,
   wherein the first data rule is executed on an attribute value of the at least one data attribute included in the edge properties of the data-ruleset edge, and
   wherein a first rule outcome, of the first set of rule outcomes, associated with the execution of the first data rule on the attribute value of the at least one data attribute is determined based on the one or more additional attributes associated as the edge properties of the ruleset-rule edge.
31. The system of 28, wherein to associate the first set of rule outcome nodes with the first set of rule nodes and the first data node, the processing circuitry is further configured to:
   create an outcome-set node for the first set of rule outcomes;
   create an outcome-set-data edge between the outcome-set node and the first data node;
   create an outcome-set-ruleset edge between the outcome-set node and the ruleset node; and
   create a set of outcome-set-outcome edges between the outcome-set node and the first set of rule outcome nodes, with an outcome-set-outcome edge being created between the outcome-set node and a first rule outcome node of the first set of rule outcome nodes.
32. The system of 31, wherein the processing circuitry is further configured to:
   associate, as node properties of the first rule outcome node, at least one of a group consisting of (i) a first timestamp associated with the execution of a first data rule, of the first set of data rules, indicated by the first rule node, using the first data node, or (ii) a first rule outcome, of the first set of rule outcomes, associated with the execution of the first data rule; and
   associate, as edge properties of the outcome-set-outcome edge, at least one of the group consisting of the first timestamp or the first rule outcome.
33. The system of 1, wherein the processing circuitry is further configured to:
   receive a query that comprises a reference value;
   identify, in the graph, at least one node having a data value that is associated with the reference value, wherein the identified node corresponds to one of a group consisting of a data node or a rule node;
   identify a set of edges associated with the identified node;
   identify a set of nodes linked to the identified set of edges, wherein the identified set of nodes includes at least one of a group consisting of one or more data nodes, one or more rule nodes, or one or more rule outcome nodes; and
   generate a response to the query based on at least one of a group consisting of (i) the identified node, (ii) node properties of the identified node, (iii) the set of edges, (iv) edge properties of each of the set of edges, (v) the set of nodes, or (vi) node properties of each of the set of nodes.
34. A method, comprising:
   generating, by processing circuitry, a graph based on a plurality of data rules,
      wherein the step of generating the graph further comprises:
         creating, by the processing circuitry, a first data node;
         identifying, by the processing circuitry, from the plurality of data rules, a first set of data rules associated with the first data node;
         creating, by the processing circuitry, a first set of rule nodes indicative of the first set of data rules;
         associating, by the processing circuitry, the first set of rule nodes with the first data node;
         executing, by the processing circuitry, based on the association of the first set of rule nodes with the first data node, the first set of data rules to generate a first set of rule outcomes;
         creating, by the processing circuitry, a first set of rule outcome nodes indicative of the first set of rule outcomes; and
         associating, by the processing circuitry, the first set of rule outcome nodes with the first set of rule nodes and the first data node, and
      wherein the generated graph facilitates query response generation.

1. A system, comprising:
processing circuitry configured to generate a graph based on a plurality of data rules,
wherein to generate the graph, the processing circuitry is further configured to:
create a first data node;
identify, from the plurality of data rules, a first set of data rules associated with the first data node;
create a first set of rule nodes indicative of the first set of data rules;
associate, via a set of first edges, the first set of rule nodes with the first data node;
execute, based on the association of the first set of rule nodes with the first data node, the first set of data rules to generate a first set of rule outcomes;
create a first set of rule outcome nodes indicative of the first set of rule outcomes,
wherein a first rule outcome node, of the first set of rule outcome nodes, is created based on an execution of a first data rule, of the first set of data rules, indicated by a first rule node, of the first set of rule nodes, using the first data node at a first time instance; and
associate, via a set of second edges, the first set of rule outcome nodes with the first set of rule nodes and the first data node, and
wherein the generated graph is configured to enable query response generation.

2. The system of claim 1, wherein a data rule, of the plurality of data rules, adheres to one of a group consisting of completeness, uniqueness, consistency, accuracy, or conformity.

3. The system of claim 1, wherein the set of first edges comprises a set of data-rule edges, and wherein to associate the first set of rule nodes with the first data node, the processing circuitry is further configured to create the set of data-rule edges between the first data node and the first set of rule nodes, with a data-rule edge of the set of data-rule edges being created between the first data node and a first rule node of the first set of rule nodes.

4. The system of claim 3, wherein the processing circuitry is further configured to:
determine, for the first data node, a first set of data attributes that indicates characteristics of the first data node;
determine, for the first rule node, a first set of rule attributes that comprises at least one of a group consisting of (i) a category of a first data rule, of the first set of data rules, indicated by the first rule node or (ii) a type of the first data rule;
determine, for the data-rule edge, a set of edge attributes that comprises at least one of a group consisting of (i) a scope of the first data rule, (ii) at least one data attribute, of the first set of data attributes, on which the first data rule is to be executed, or (iii) one or more additional attributes defining a criterion associated with the execution of the first data rule; and
assign the first set of data attributes as node properties of the first data node, the first set of rule attributes as node properties of the first rule node, and the set of edge attributes as edge properties of the data-rule edge.

5. The system of claim 4, wherein the set of edge attributes of the data-rule edge further comprises one or more data attributes, of the first set of data attributes, that are excluded from the execution of the first data rule, wherein the one or more data attributes are distinct from the at least one data attribute on which the first data rule is executed.

6. The system of claim 4, wherein the scope of the first data rule indicates whether the first data rule is to be executed on the first data node in entirety or on a data attribute of the first data node.

7. The system of claim 4,
wherein the first data rule is executed on an attribute value of the at least one data attribute included in the set of edge attributes, and
wherein a first rule outcome, of the first set of rule outcomes, associated with the execution of the first data rule is determined based on the one or more additional attributes.

8. The system of claim 1, wherein the set of second edges comprises a set of outcome-rule edges and a set of outcome-data edges, and wherein to associate the first set of rule outcome nodes with the first set of rule nodes and the first data node, the processing circuitry is further configured to:
create the set of outcome-rule edges between the first set of rule outcome nodes and the first set of rule nodes, with an outcome-rule edge of the set of outcome-rule edges being created between a first rule outcome node, of the first set of rule outcome nodes, and a first rule node, of the first set of rule nodes; and
create a set of outcome-data edges between the first set of rule outcome nodes and the first data node, with an outcome-data edge of the set of outcome-data edges being created between the first rule outcome node and the first data node.

9. The system of claim 8, wherein the processing circuitry is further configured to:
determine, for the first rule outcome node, a first set of outcome attributes that comprises at least one of a group consisting of (i) a first timestamp associated with the execution of a first data rule, of the first set of data rules, indicated by the first rule node, using the first data node, or (ii) a first rule outcome, of the first set of rule outcomes, associated with the execution of the first data rule; and
associate the first set of outcome attributes as node properties of the first rule outcome node.

10. The system of claim 8,
wherein the processing circuitry is further configured to determine, for the outcome-rule edge, a set of edge attributes that comprises (i) a category of a first data rule, of the first set of data rules, indicated by the first rule node, (ii) a type of the first data rule, (iii) a first timestamp associated with the execution of the first data rule using the first data node, or (iv) a first rule outcome, of the first set of rule outcomes, associated with the execution of the first data rule, and associate the determined set of edge attributes as edge properties thereof, and
wherein the processing circuitry is further configured to determine, for the outcome-data edge, another set of edge attributes that comprises (i) the first timestamp, (ii) an attribute value of each data attribute, of the first data node, on which the first data rule is executed, or (iii) the first rule outcome, and associate the determined set of edge attributes as edge properties thereof.

11. The system of claim 1,
wherein a second rule outcome node, of the first set of rule outcome nodes, is created based on the execution of the first data rule using the first data node at a second time instance.

12. The system of claim 11, wherein the execution of the first data rule using the first data node at the second time instance is based on a change in an attribute value associated with the first data node.

13. The system of claim 11, wherein the execution of the first data rule using the first data node at the second time instance is based on a lapse of a periodic time interval.

14. The system of claim 1,
wherein to associate a first rule node, of the first set of rule nodes, with the first data node, the processing circuitry is further configured to create a first data-rule edge and a second data-rule edge between the first data node and the first rule node,
wherein edge properties of the first data-rule edge comprise at least one of a group consisting of (i) a category of a first data rule, of the first set of data rules, indicated by the first rule node, (ii) a type of the first data rule, (iii) a scope of the first data rule, (iv) a first data attribute of the first data node on which the first data rule is to be executed, or (v) a first set of additional attributes defining a first criterion associated with the execution of the first data rule, and
wherein edge properties of the second data-rule edge comprise at least one of a group consisting of (i) the category of the first data rule, (ii) the type of the first data rule, (iii) the scope of the first data rule, (iv) a second data attribute of the first data node on which the first data rule is to be executed, or (v) a second set of additional attributes defining a second criterion associated with the execution of the first data rule.

15. The system of claim 14,
wherein (i) the first data rule is executed on a first attribute value of the first data attribute at a first time instance, (ii) a first rule outcome, of the first set of rule outcomes, associated with the execution of the first data rule on the first attribute value is determined based on the first set of additional attributes, and (iii) a first rule outcome node, of the first set of rule outcome nodes, indicates the first rule outcome, and
wherein (i) the first data rule is executed on a second attribute value of the second data attribute at a second time instance, (ii) a second rule outcome, of the first set of rule outcomes, associated with the execution of the first data rule on the second attribute value is determined based on the second set of additional attributes, and (iii) a second rule outcome node, of the first set of rule outcome nodes, indicates the second rule outcome.

16. The system of claim 1, wherein to generate the graph, the processing circuitry is further configured to:
create a second data node;
identify, from the plurality of data rules, a second set of data rules associated with the second data node, wherein the first set of data rules and the second set of data rules have at least one common data rule;
associate, with the second data node, a common rule node, of the first set of rule nodes, that indicates the at least one common data rule, wherein based on the association of the common rule node with the second data node, the at least one common data rule is executed using the second data node to generate another rule outcome;
create another rule outcome node indicative of the other rule outcome generated based on the execution of the at least one common data rule using the second data node; and
associate the other rule outcome node with the common rule node and the second data node.

17. The system of claim 1, wherein to associate the first set of rule nodes with the first data node, the processing circuitry is further configured to:
create a ruleset node for the first set of data rules;
create a data-ruleset edge between the first data node and the ruleset node; and
create a set of ruleset-rule edges between the ruleset node and the first set of rule nodes, with a ruleset-rule edge being created between the ruleset node and a first rule node of the first set of rule nodes.

18. The system of claim 17, wherein to associate the first set of rule outcome nodes with the first set of rule nodes and the first data node, the processing circuitry is further configured to:
create an outcome-set node for the first set of rule outcomes;
create an outcome-set-data edge between the outcome-set node and the first data node;
create an outcome-set-ruleset edge between the outcome-set node and the ruleset node; and
create a set of outcome-set-outcome edges between the outcome-set node and the first set of rule outcome nodes, with an outcome-set-outcome edge being created between the outcome-set node and a first rule outcome node of the first set of rule outcome nodes.

19. The system of claim 1, wherein the processing circuitry is further configured to:
receive a query that comprises a reference value;
identify, in the graph, at least one node having a data value that is associated with the reference value, wherein the identified node corresponds to one of a group consisting of a data node or a rule node;
identify a set of edges associated with the identified node;
identify a set of nodes linked to the identified set of edges, wherein the identified set of nodes includes at least one of a group consisting of one or more data nodes, one or more rule nodes, or one or more rule outcome nodes; and
generate a response to the query based on at least one of a group consisting of (i) the identified node, (ii) node properties of the identified node, (iii) the set of edges, (iv) edge properties of each of the set of edges, (v) the set of nodes, or (vi) node properties of each of the set of nodes.

20. A method, comprising:
generating, by processing circuitry, a graph based on a plurality of data rules,
wherein the step of generating the graph further comprises:
creating, by the processing circuitry, a first data node;
identifying, by the processing circuitry, from the plurality of data rules, a first set of data rules associated with the first data node;
creating, by the processing circuitry, a first set of rule nodes indicative of the first set of data rules;
associating, by the processing circuitry and via a set of first edges, the first set of rule nodes with the first data node;
executing, by the processing circuitry, based on the association of the first set of rule nodes with the first data node, the first set of data rules to generate a first set of rule outcomes;
creating, by the processing circuitry, a first set of rule outcome nodes indicative of the first set of rule outcomes, wherein a first rule outcome node, of the first set of rule outcome nodes, is created based on an execution of a first data rule, of the first set of data rules, indicated by a first rule node, of the first set of rule nodes, using the first data node at a first time instance; and
associating, by the processing circuitry and via a set of second edges, the first set of rule outcome nodes with the first set of rule nodes and the first data node, and
wherein the generated graph is configured to enable query response generation.
